(19) United States
(12) Patent Application Publication
(10) Pub. No.: US 2026/0264992 A1
(43) Pub. Date: Sep. 10, 2026

(54) WORKSTATION, WAREHOUSING SYSTEM, AND METHOD FOR CONTROLLIONG WORKSTATION

(71) Applicant: HAI ROBOTICS CO., LTD., Shenzhen (CN)

(72) Inventor: Bo XU, Shenzhen (CN)

(73) Assignee: HAI ROBOTICS CO., LTD., Shenzhen (CN)

(21) Appl. No.: 19/659,974

(22) Filed: Apr. 27, 2026

Related U.S. Application Data
(63) Continuation of application No. PCT/CN2024/125917, filed on Oct. 18, 2024.

(30) Foreign Application Priority Data
Nov. 28, 2023 (CN) 202311611534.3

(51) Int. Cl. B65G 1/137

(52) U.S. Cl. CPC B65G 1/1378; B65G 2209/02; B65G 2209/10

(57) ABSTRACT

A workstation includes a sorting mechanism and a buffer mechanism. The sorting mechanism includes a source container conveyor and an order container conveyor. A source container is configured to store to-be-sorted goods. The source container conveyor has a picking position. An order container is configured to receive goods sorted from the source container. The order container conveyor has a delivery position. When the source container arrives at the picking position, the to-be-sorted goods in the source container are picked and placed into an order container at the delivery position. The buffer mechanism is located on a lateral side of the sorting mechanism, and configured to buff an order container for which a picking task is incomplete, and convey the order container to the delivery position based on a conveying sequence. The conveying sequence is determined based on a sequence that the source container arrives at the picking position.

### CROSS-REFERENCES

This application is a continuation of International Patent Application No. PCT/CN2024/125917 filed on October 18, 2024, which claims priority to Chinese Patent Application No. 202311611534.3, filed with the China National Intellectual Property Administration on November 28, 2023 and entitled "Workstation, warehousing system, and method for controlling workstation", the disclosures of which are incorporated herein by reference in their entireties.

### TECHNICAL FIELD

This application relates to the field of warehousing and logistics technologies, and in particular, to a workstation, a warehousing system, and a method for controlling workstation.

### BACKGROUND OF THE INVENTION

Current logistics centers have increasingly high requirements on efficiency of logistics and warehousing distribution. Logistics sorting is a very important link in logistics and warehousing distribution, and overall outbound efficiency of goods can be improved when sustained and high-efficiency sorting work is ensured.

In a related technology, a logistics system generally includes apparatuses such as a warehousing rack, a sorting workstation, and a transport device. The sorting workstation includes a sorting apparatus and a put wall. In inbound and outbound processes of goods, a sorting person may complete sorting work of the goods. The goods are usually classified based on an order task or a goods type and placed into storage slots on the put wall based on a corresponding classification result. Inbound and outbound transport operation of the goods may be performed on classified goods by the transport device such as a transport robot.

However, sorting efficiency of the current sorting workstation is low, and a problem that goods are incorrectly sorted is prone to occur.

### SUMMARY OF THE INVENTION

This application provides a workstation, a warehousing system, and a method for controlling workstation, so that technical problems that sorting efficiency of a current sorting workstation is low and goods are incorrectly sorted easily can be resolved.

According to a first aspect, this application provides a workstation, including a sorting mechanism and a buffer mechanism. The sorting mechanism includes a source container conveyor and an order container conveyor. The source container conveyor is configured to convey a source container. The source container is configured to store to-be-sorted goods. The source container conveyor has at least one picking position. The order container conveyor is configured to convey an order container. The order container is configured to receive goods sorted from the source container. The order container conveyor has at least one delivery position. When the source container arrives at the picking position, the to-be-sorted goods in the source container are picked and placed into an order container at the delivery position. The buffer mechanism is located on a lateral side of the sorting mechanism, and configured to buff an order container for which a picking task is incomplete, and convey the order container to the delivery position based on a conveying sequence. The conveying sequence is determined based on a sequence in which the source container arrives at the picking position.

The buffer mechanism is disposed in the workstation provided in this embodiment of this application, and the order container for which the picking task is incomplete may be buffered in an order container picking process, so that the sorting mechanism can switch to another order container to perform an order grading operation, thereby improving goods sorting efficiency and avoiding congestion of the order container.

According to a second aspect, this application provides a warehousing system, including a storage rack, a carrying mechanism, and a workstation. The carrying mechanism is configured to carry a to-be-sorted source container from the storage rack to the workstation or carry a sorted source container from the workstation to the storage rack.

The warehousing system provided in this embodiment of this application can improve efficiency of an entire process from an outbound operation to sorting of goods.

According to a third aspect, this application provides a method for controlling workstation, performed by a controller of a workstation. The method includes: obtaining an order task; controlling a source container conveyor to convey a source container corresponding to the order task to a picking position of the source container conveyor; controlling an order container conveyor to convey an order container corresponding to the source container to a delivery position on the order container conveyor; after it is determined that items in the source container have been delivered to the order container, determining whether a picking task is completed for the order container, and if not, controlling the order container conveyor to convey the order container to a buffer mechanism for temporary storage; and controlling the buffer mechanism to convey the temporarily stored order container to the delivery position based on a conveying sequence, where the conveying sequence is determined based on a sequence in which the source container arrives at the picking position.

In addition to the foregoing described technical problems resolved by the embodiments of this application, the technical features constituting the technical solutions, and the beneficial effects brought by the technical features of the technical solutions, this application provides further technical problems addressable by the provided workstation, warehousing system, and method for controlling workstation, along with additional technical features included in the technical solutions and the beneficial effects of the technical features. These aspects will be described in further detail in specific implementations.

### BRIEF DESCRIPTION OF DRAWINGS

To describe the technical solutions of embodiments of this application or the existing technology clearer, the following briefly introduces the accompanying drawings required for describing the embodiments and the existing technology. It is clear that the accompanying drawings in the following description show some embodiments of this application, and a person of ordinary skill in the art may still derive other drawings from these accompanying drawings without creative efforts.

FIG. 1 is a schematic diagram of a first structure of a workstation according to an embodiment of this application;

FIG. 2 is a front view of a first structure of a workstation according to an embodiment of this application;

FIG. 3 is a top view of a first structure of a workstation according to an embodiment of this application;

FIG. 4 is a schematic diagram of a first structure of a buffer mechanism in a workstation according to an embodiment of this application;

FIG. 5 is a schematic diagram of a second structure of a workstation according to an embodiment of this application;

FIG. 6 is a side view of a second structure of a workstation according to an embodiment of this application;

FIG. 7 is a schematic diagram of a second structure of a buffer mechanism in a workstation according to an embodiment of this application;

FIG. 8 is a schematic diagram of a third structure of a workstation according to an embodiment of this application;

FIG. 9 is a side view of a third structure of a workstation according to an embodiment of this application;

FIG. 10 is a schematic diagram of a third structure of a buffer mechanism in a workstation according to an embodiment of this application;

FIG. 11 is a schematic diagram 1 of a structure of a source container conveyor in a workstation according to an embodiment of this application;

FIG. 12 is a schematic diagram 2 of a structure of a source container conveyor in a workstation according to an embodiment of this application;

FIG. 13 is a schematic diagram of cooperation between a plurality of workstations according to an embodiment of this application;

FIG. 14 is a schematic diagram 1 of a structure of a sorting mechanism according to an embodiment of this application;

FIG. 15 is a schematic diagram 2 of a structure of a sorting mechanism according to an embodiment of this application;

FIG. 16 is a front view of a sorting mechanism according to an embodiment of this application;

FIG. 17 is a cross-sectional view taken along a direction A-A in FIG. 16;

FIG. 18 is a partial view of a position C in FIG. 17;

FIG. 19 is a partial view of a position D in FIG. 17;

FIG. 20 is a side view of a sorting mechanism according to an embodiment of this application;

FIG. 21 is a cross-sectional view taken along a direction B-B in FIG. 20;

FIG. 22 is a partial view of a position E in FIG. 21;

FIG. 23 is a schematic diagram of a structure of a three-dimensional storage mechanism according to an embodiment of this application;

FIG. 24 is a side view of a three-dimensional storage mechanism according to an embodiment of this application;

FIG. 25 is a schematic diagram 1 of cooperation between a first rack and a lifting apparatus in a three-dimensional storage mechanism according to an embodiment of this application;

FIG. 26 is a schematic diagram 2 of cooperation between a first rack and a lifting apparatus in a three-dimensional storage mechanism according to an embodiment of this application;

FIG. 27 is a schematic diagram of a structure of a second rack in a three-dimensional storage mechanism according to an embodiment of this application;

FIG. 28 is a schematic diagram of a structure of a lifting apparatus in a three-dimensional storage mechanism according to an embodiment of this application;

FIG. 29 is a bottom view of a lifting apparatus in a three-dimensional storage mechanism according to an embodiment of this application;

FIG. 30 is a front view of a lifting apparatus in a three-dimensional storage mechanism according to an embodiment of this application;

FIG. 31 is a schematic diagram 1 of a structure of a picking and placing assembly in a three-dimensional storage mechanism according to an embodiment of this application;

FIG. 32 is a schematic diagram 2 of a structure of a picking and placing assembly in a three-dimensional storage mechanism according to an embodiment of this application;

FIG. 33 is a schematic diagram of a structure of a telescopic member in a three-dimensional storage mechanism according to an embodiment of this application;

FIG. 34 is a front view of a telescopic member in a three-dimensional storage mechanism according to an embodiment of this application;

FIG. 35 is a schematic diagram of a first structure of a planar storage mechanism according to an embodiment of this application;

FIG. 36 is a schematic diagram of a second structure of a planar storage mechanism according to an embodiment of this application;

FIG. 37 is a schematic diagram of a third structure of a planar storage mechanism according to an embodiment of this application;

FIG. 38 is a schematic diagram of a fourth structure of a planar storage mechanism according to an embodiment of this application;

FIG. 39 is a schematic diagram of steps of a method for controlling workstation according to an embodiment of this application;

FIG. 40 is a specific flowchart of a method for controlling workstation according to an embodiment of this application;

FIG. 41 is a schematic diagram of steps of an order processing method according to an embodiment of this application; and

FIG. 42 is a specific flowchart of an order processing method according to an embodiment of this application.

Description of reference numerals:

1-Workstation; 2-Buffer mechanism; 3-Sorting mechanism; 30-Sorting position; 31-Support column; 32-Adjustment member; 33-First connection hole; 34-Second connection hole; 4-Source container conveyor; 40-Picking position; 41-Return mechanism; 42-Return sequencing region; 43-First conveyed member; 44-First baffle; 45-Source container inlet; 46-Source container outlet; 49- Source container; 5-Order container conveyor; 50-delivery position; 51-Picking channel; 510-input end; 511-output end; 52-Vacant container line; 53-Full container line; 54-Second conveyed member; 55-Second baffle; 56-Queuing position; 57-Return position; 58- transfer mechanism; 59-Order container; 59’- candidate order container; 6-Return line; 7-Detection mechanism; 71-First weighing unit; 72-Second weighing unit; 73-First grating unit; 74-Second grating unit; 8-Box switch button;

20-Planar storage mechanism; 21-Candidate channel; 210-Transfer device; 22-Queuing channel; 23a-First temporary storage position; 23b-Second temporary storage position; 24-Transfer position;

10-Three-dimensional storage mechanism; 11-Storage layer; 111-Storage position; 12-Conveying layer; 121- inbound port; 122- outbound port; 13-Lifting channel; 14-Inbound and outbound channel;

100-First rack; 110-First conveyor;

200-Second rack; 220-Second conveyor;

300-Lifting apparatus; 301-Guide wheel; 310-Lifting body; 320-Side shift assembly; 321-Side shift bracket; 322-Conveying mechanism; 330-Picking and placing assembly; 331-Fixing member; 332-Telescopic member; 3321-Telescopic body; 3322-Abutment member; 3323-Fourth driving unit; 333-Third guide rail; 334-Third driving assembly; 3341-Third driving unit; 3342-Third flexible transmission member; 3343-Third transmission wheel; 340-Second driving assembly; 341-Second driving unit; 342-Second flexible transmission member; 343-Second transmission wheel; 350-Second guide rail;

400-First driving assembly 410-First driving unit 420-First flexible transmission member. 430-First transmission wheel; and

500-First guide rail.

### DETAILED DESCRIPTION

To make the objectives, technical solutions, and advantages of embodiments of this application clearer, the following will clearly and completely describe the technical solutions in the embodiments of this application with reference to the accompanying drawings in the embodiments of this application. It is clear that the described embodiments are a part of the embodiments of this application, but not all of them. All other embodiments obtained by a person of ordinary skill in the art based on the embodiments of this application without creative efforts shall fall within the protection scope of this application.

First, a person skilled in the art should understand that the implementations are merely used for explaining the technical principle of the present disclosure, and are not intended to limit the protection scope of this application. A person skilled in the art may make adjustments as required, to adapt to a specific application.

In addition, it should be noted that, in the description of this application, terms such as "above", "below", "left", "right", "front", "rear", "inner", and "outer" that indicate directions or position relationships are based on the directions or position relationships shown in the accompanying drawings. This is merely for ease of description, and does not indicate or imply that an apparatus or component needs to have a specific orientation, and is constructed and operated in a specific orientation, and therefore cannot be understood as a limitation to this application.

In addition, it should be further noted that, in the description of this application, unless otherwise clearly specified and limited, the terms "coupled" and "connected" should be understood in a broad sense, for example, a connection may be a fixed connection, a detachable connection, or an integral connection; it may alternatively be a mechanical connection, an electrical connection, or communication between the interiors of two components. A person skilled in the art may understand specific meanings of the foregoing terms in this application.

In the description of this specification, references to the terms such as "one embodiment," "some embodiments," "an exemplary embodiment," "example," "specific example," or "some examples" mean that a specific feature, structure, material, or characteristic described in connection with the embodiment or example is included in at least one embodiment or example of the present disclosure. In this specification, schematic references to the foregoing terms do not necessarily refer to the same embodiment or example. Moreover, the described specific features, structures, materials, or characteristics may be combined in a suitable manner in any one or more embodiments or examples.

Three-dimensional warehouses are widely used in the field of warehousing and logistics due to a large storage capacity of the three-dimensional warehouses. The three-dimensional warehouse usually includes a plurality of racks. The racks have a large height, and have a plurality of rows and a plurality of columns of storage positions to store material boxes. During inbound and outbound operations of goods, stacker cranes or robots are usually used to pick the goods from the racks and place the goods onto the racks. Because a large quantity of goods are stored on the racks and the racks occupy a large area, a large warehouse has low efficiency per square meter. The efficiency per square meter refers to a ratio of inbound and outbound efficiency to a warehouse occupation area, that is, throughput efficiency per unit area.

In view of the foregoing problems, an embodiment of this application provides a workstation. A buffer mechanism is disposed, and an order container for which a picking task is incomplete may be buffered in an order container picking process, so that a sorting mechanism can switch to another order container to perform an order grading operation, thereby improving goods sorting efficiency and avoiding congestion of the order container.

For ease of understanding, an application scenario applicable to this embodiment of this application is described below first.

The workstation provided in this embodiment of this application may be used in various fields, such as inbound and outbound operations of inventory products in manufacturing factories, inbound and outbound operations of inventory products in retail industries, and inbound and outbound operations and sorting of express parcels in e-commerce logistics. For example, a three-dimensional storage mechanism provided in this embodiment of this application may be used in a picking link for temporarily storing a semi-finished product order, or used in an automated production line with fluctuating production rhythms, or used in automated inbound and outbound operations of a plurality of types of products for temporary storage and sequencing of the plurality of types of products.

In addition, a product whose transportation and inbound and outbound operations are involved in the three-dimensional storage mechanism provided in this embodiment of this application may be an industrial component, an electronic part or product, a pharmaceutical, a clothing accessory, food, a book, or the like. The goods in this application may be the foregoing listed product, or may be a material box or a tray carrying the foregoing product. This is not specifically limited in this embodiment of this application.

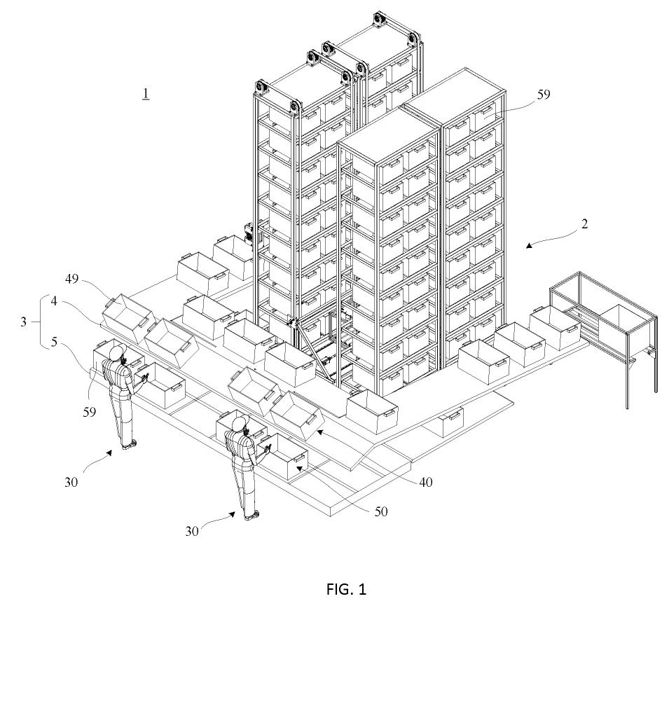

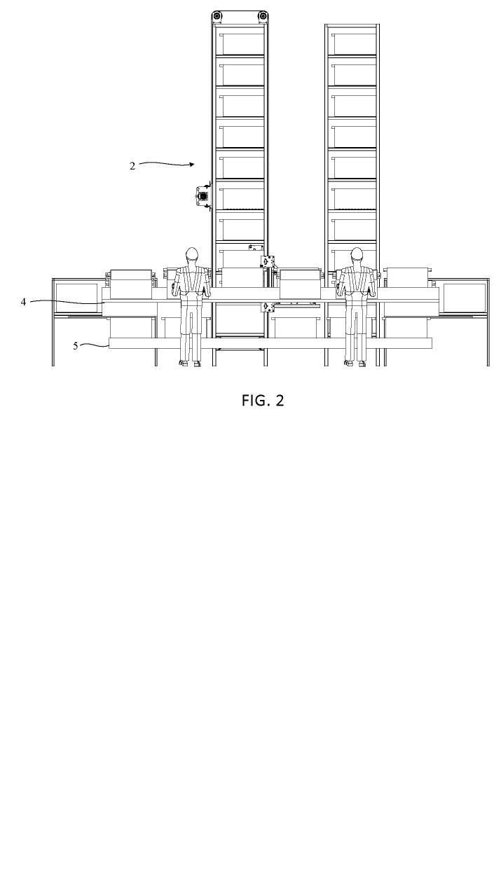

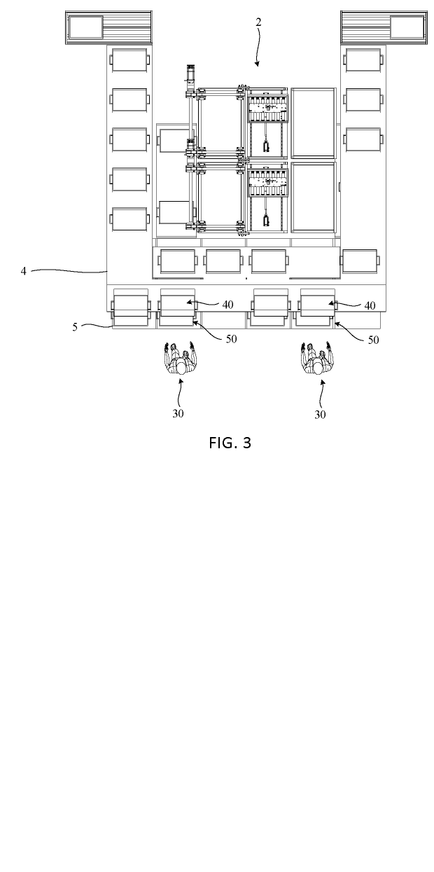

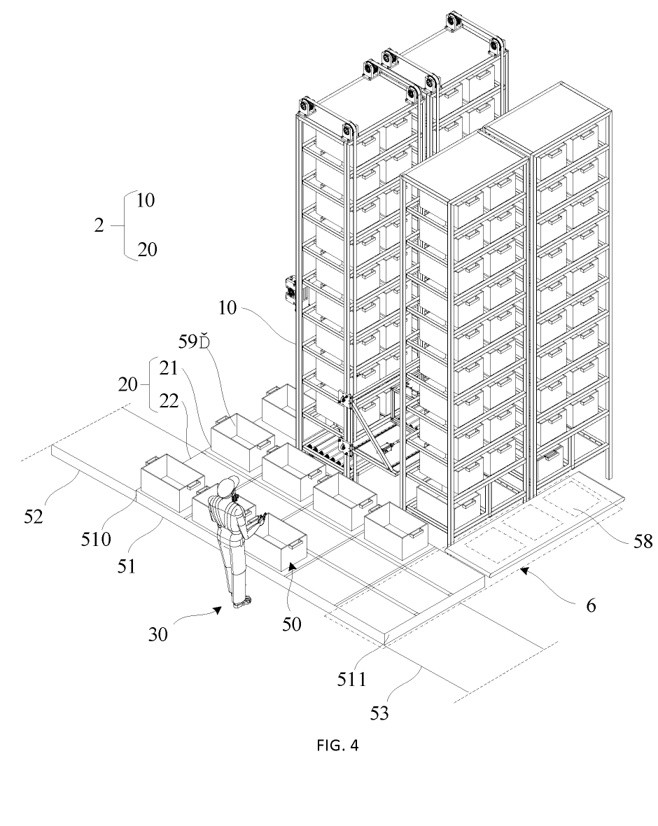

FIG. 1 is a schematic diagram of a first structure of a workstation according to an embodiment of this application, FIG. 2 is a front view of a first structure of a workstation according to an embodiment of this application, FIG. 3 is a top view of a first structure of a workstation according to an embodiment of this application, and FIG. 4 is a schematic diagram of a first structure of a buffer mechanism in a workstation according to an embodiment of this application.

As shown in FIG. 1 to FIG. 4, an embodiment of this application provides a workstation 1. The workstation 1 includes a sorting mechanism 3 and a buffer mechanism 2. The sorting mechanism 3 includes a source container conveyor 4 and an order container conveyor 5. The source container conveyor 4 is configured to convey a source container 49. The source container 49 is configured to store to-be-sorted goods. The order container conveyor 5 is configured to convey an order container 59. The order container 59 is configured to receive goods sorted from the source container 49. The buffer mechanism 2 is configured to buffer an order container 59 for which a picking task is incomplete.

It may be understood that the source container conveyor 4 has at least one picking position 40, and the order container conveyor 5 has at least one delivery position 50. When the source container arrives at the picking position 40, the to-be-sorted goods in the source container 49 are picked and placed into an order container 59 at the delivery position 50.

In some implementations, the buffer mechanism 2 is located on a lateral side of the sorting mechanism 3 and conveys the order container 59 to the delivery position 50 based on a conveying sequence. The conveying sequence may be determined based on a sequence in which the source container 49 arrives at the picking position 40.

It should be noted that the sorting mechanism 3 may switch between the source container 49 and the order container 59 after completing a sorting operation. According to an allocated order task, a mapping relationship exists between the source container 49 and the order container 59. Based on the sequence in which the source container 49 arrives at the picking position 40, the corresponding order container 59 may form the corresponding conveying sequence, so that the mutually mapped source container 49 and order container 59 synchronously arrive at the picking position 40 and the delivery position 50 respectively.

In the workstation 1 provided in this embodiment of this application, a next step for the order container 59 is determined based on a specific situation after one order picking operation is completed. If picking have been completed for all order tasks corresponding to the order container 59, the order container 59 may be outputted from the sorting mechanism 3. If picking have been completed for not all the order tasks corresponding to the order container 59, the order container 59 may be conveyed to the buffer mechanism 2 for temporary storage, and the delivery position 50 may be switched to a next order container 59 for a sorting operation. An order container 59 on which sorting is incomplete does not need to stop at the delivery position 50 to wait, thereby improving overall logistics efficiency of the workstation 1.

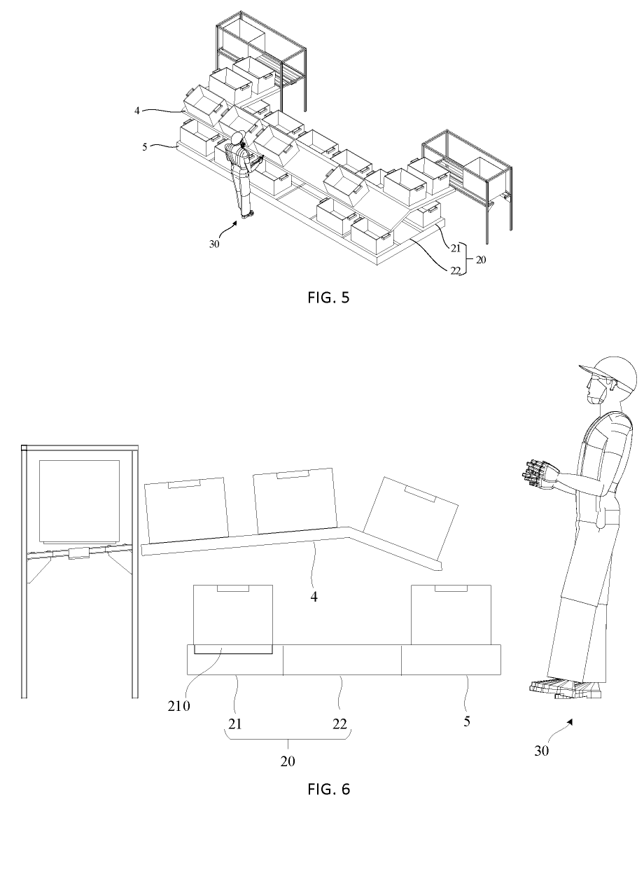

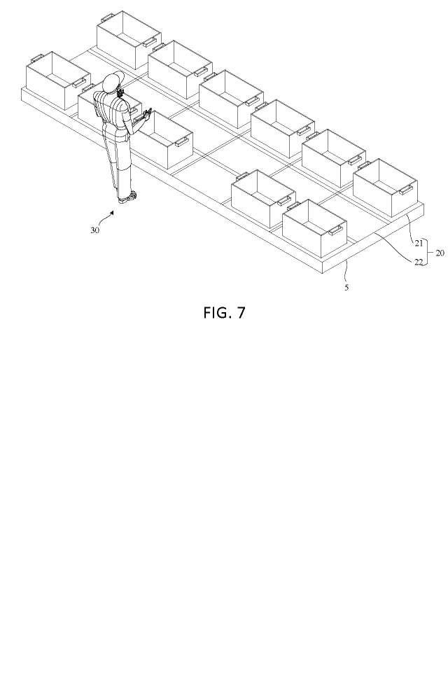

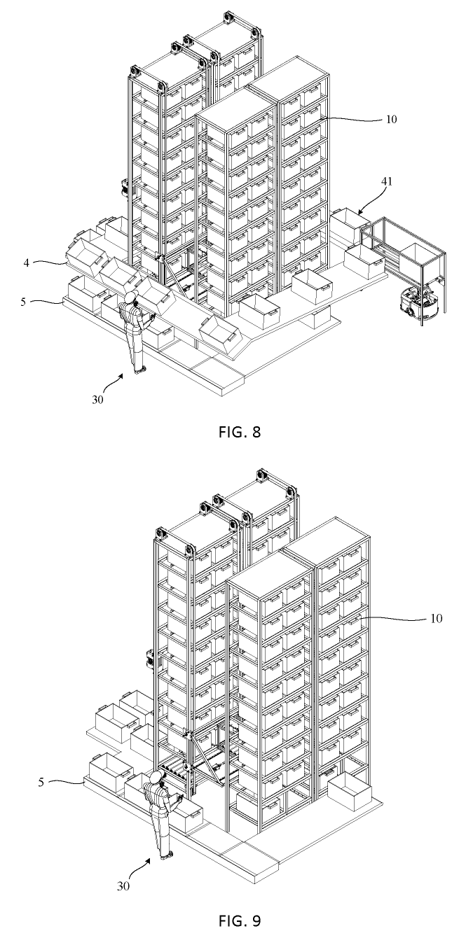

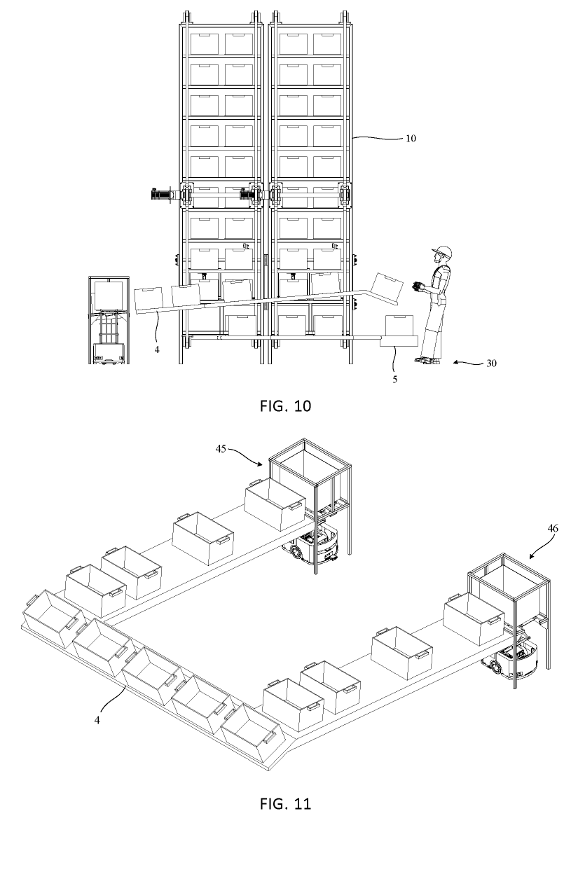

FIG. 5 is a schematic diagram of a second structure of a workstation according to an embodiment of this application, FIG. 6 is a side view of a second structure of a workstation according to an embodiment of this application, FIG. 7 is a schematic diagram of a second structure of a buffer mechanism in a workstation according to an embodiment of this application, FIG. 8 is a schematic diagram of a third structure of a workstation according to an embodiment of this application, FIG. 9 is a side view of a third structure of a workstation according to an embodiment of this application, and FIG. 10 is a schematic diagram of a third structure of a buffer mechanism in a workstation according to an embodiment of this application.

In some embodiments, the buffer mechanism 2 may include at least one of a three-dimensional storage mechanism 10 and a planar storage mechanism 20. For example, as shown in FIG. 5 to FIG. 7, the buffer mechanism 2 may include only the planar storage mechanism 20. Alternatively, as shown in FIG. 8 to FIG. 10, the buffer mechanism 2 may include only the three-dimensional storage mechanism 10. Alternatively, as shown in FIG. 2 to FIG. 4, the buffer mechanism 2 may include both the three-dimensional storage mechanism 10 and the planar storage mechanism 20. This is not specifically limited in this embodiment of this application.

A configuration manner of the three-dimensional storage mechanism 10 is described in detail below.

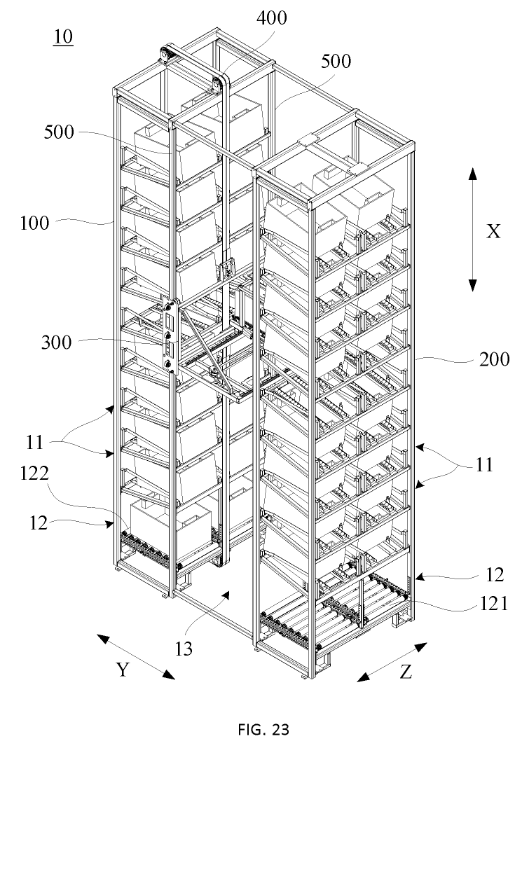

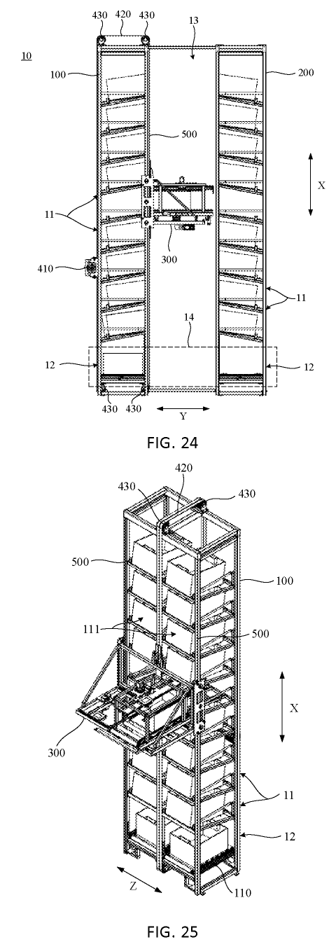

Still with reference to FIG. 1 to FIG. 4, FIG. 23, and FIG. 24, the three-dimensional storage mechanism 10 may include a rack. The rack includes a storage layer 11 and a conveying layer 12 that are arranged in a vertical direction. The storage layer 11 is configured to temporarily store the order container for which the picking task is incomplete. The conveying layer 12 is configured to dock with the order container conveyor 5.

It may be understood that, on the order container conveyor 5, when a picking task for an order container at the delivery position 50 is incomplete and the order container 59 needs to be temporarily stored, the order container 59 may be conveyed to the conveying layer 12, and then the conveying layer 12 delivers the order container 59 to the storage layer 11 for temporary storage.

For example, the conveying layer 12 has an inbound port 121 and an outbound port 122. The outbound port 122 is configured to dock with an upstream section of the order container conveyor 5, and the inbound port 121 is configured to dock with a downstream section of the order container conveyor 5. When the order container 59 for which the picking task is incomplete is delivered to the downstream section along the order container conveyor 5, the order container 59 may enter the conveying layer 12 of the three-dimensional storage mechanism 10 through the inbound port 121 and then is delivered from the conveying layer 12 to the storage layer 11. When picking needs to be performed on the temporarily stored order container 59 again, the target order container 59 may be picked from the storage layer 11, first delivered to the conveying layer 12, and then delivered to the upstream section of the order container conveyor 5 through the outbound port 122 of the conveying layer 12. The order container 59 may flow to the delivery position 50 along the order container conveyor 5, so that a picking operation can be continued.

It should be noted that two ends of the order container conveyor 5 along a conveying direction each are provided with a transfer mechanism 58, and the transfer mechanisms 58 at two ends of the order container conveyor 5 are respectively opposite to the inbound port 121 and the outbound port 122. The transfer mechanism 58 may move the order container 59 from the outbound port 122 of the conveying layer 12 to the order container conveyor 5, or the transfer mechanism 58 may move the order container 59 from the order container conveyor 5 to the inbound port 121 of the conveying layer 12.

For example, the transfer mechanism may include one or more conveying structures, such as a conveyor roller and a conveyor belt, which are driven by an electric motor. A specific transmission form used by the transfer mechanism is not limited in this embodiment of this application.

A configuration manner of the planar storage mechanism 20 is described in detail below.

Still with reference to FIG. 1 to FIG. 4, in some embodiments, the planar storage mechanism 20 may include a candidate channel 21. The order container conveyor 5 may include a picking channel 51. The candidate channel 21 is located on a lateral side of the picking channel 51. The delivery position 50 is disposed on the picking channel 51.

The candidate channel 21 is configured to place a candidate order container, to deliver the candidate order container 59’ to the picking channel 51 based on the conveying sequence. The candidate order container 59’ may include an order container 59 directly conveyed from the delivery position 50 to the candidate channel 21, or an order container 59 conveyed from the three-dimensional storage mechanism 10 to the candidate channel 21.

It may be understood that, when the order container 59 for which the picking task is incomplete is temporarily stored, duration before picking needs to be performed on the order container 59 next time may be determined or estimated based on specific order task content of the order container 59. If the duration before the next picking operation is long, the order container 59 may be temporarily stored to the three-dimensional storage mechanism 10 having a large storage capacity. When picking is performed on the order container 59 next time, the order container 59 may be picked from the three-dimensional storage mechanism 10 and delivered to the candidate channel 21. If the duration before the next picking performed on the order container 59 is short, the order container 59 may be directly conveyed to the candidate channel 21. In this way, conveying duration required for entering the delivery position 50 when picking is performed on the order container next time can be shortened, thereby improving the logistics efficiency.

It should be noted that, in the workstation 1 provided in this embodiment of this application, when the three-dimensional storage mechanism 10 and the planar storage mechanism 20 are both disposed, the order container 59 that need to be temporarily stored may be diverted, thereby improving the logistics efficiency while fully using temporary storage space.

In some embodiments, the candidate channel 21 and the picking channel 51 are parallel to each other. The candidate channel 21 is provided with a transfer device 210 (as shown in FIG. 6). The transfer device 210 is configured to transfer the candidate order container 59’ to the picking channel 51 in a direction perpendicular to the picking channel 51, so that the candidate order container 59’ arrives at the delivery position 50 based on the conveying sequence.

It may be understood that the transfer device 210 is configured to transfer and deliver the order container 59 between the candidate channel 21 and the picking channel 51. When the candidate channel 21 and the picking channel 51 are parallel to each other, a direction in which the transfer device 210 transfers the order container 59 is perpendicular to a direction in which the candidate channel 21 and the picking channel 51 deliver the order container 59.

For example, the transfer device 210 may include one or more conveying structures, such as a conveyor roller and a conveyor belt. A structure of the transfer device 210 may be the same as or similar to that of the foregoing transfer mechanism, and details are not described herein again.

In some embodiments, the planar storage mechanism 20 may further include a queuing channel 22. The queuing channel 22 is located between the candidate channel 21 and the picking channel 51. A to-be-picked candidate order container 59’ in the candidate channel 21 is configured to first pass through the queuing channel 22 and then enter the picking channel 51.

It may be understood that, because a preset conveying sequence needs to be formed when the order container 59 is conveyed from the candidate channel 21 to the picking channel 51, the conveying sequence may be the same as or different from a sequence in which the order container 49 enters the planar storage mechanism 20. Therefore, the queuing channel 22 is disposed to adjust a sequence and a queuing position of the order container 59, so that the preset conveying sequence can be quickly and accurately formed when the order container 59 enters the picking channel 51 from the candidate channel 21, thereby avoiding a box jam or a sequencing error.

For example, the candidate channel 21, the queuing channel 22, and the picking channel 51 are parallel to each other. The candidate channel 21 is provided with a transfer device 210. The transfer device 210 is configured to transfer the candidate order container 59’ to the queuing channel 22 along a direction perpendicular to the queuing channel 22, to queue the candidate order containers 59’ in the queuing channel 22 based on the conveying sequence and sequentially convey the candidate order container 59’ from the queuing channel 22 to the picking channel 51.

It should be noted that a specific structure and a configuration manner of the transfer device 210 between the candidate channel 21 and the queuing channel 22 may be the same as or similar to that of the transfer device 210 between the candidate channel 21 and the picking channel 51, and details are not described herein again.

With reference to FIG. 2 to FIG. 4, in some embodiments, the workstation 1 provided in this embodiment of this application may further include a return line 6. The return line 6 is located at an end portion of the candidate channel 21 and an end portion of the picking channel 51, and the return line 6 communicates the candidate channel 21 and with picking channel 51. At least a part of order containers for which picking is incomplete in the picking channel 51 return to the candidate channel 21 through the return line 6.

It may be understood that the order container 59 for which picking is incomplete at the delivery position 50 is conveyed back to the return line 6 along a conveying direction of the order container conveyor 5 and then flows to the candidate channel 21 along the return line 6.

For example, the return line 6 may be perpendicular to a conveying direction of the candidate channel 21 and the picking channel 51.

In some embodiments, the workstation 1 provided in this embodiment of this application may further include a vacant container line 52 and a full container line 53. The vacant container line 52 is connected to an input end 510 of the picking channel 51 and configured to convey a vacant order container to the picking channel 51. The full container line 53 is docked to an output end 511 of the picking channel 51 and configured to receive an order container for which picking is completed in the picking channel 51.

It should be noted that the vacant container line 52 may be docked to a device such as a transport robot or a conveyor line outside the workstation 1, to receive the vacant order container. The full container line 53 may also be docked to a device such as a transport robot or a conveyor line outside the workstation 1, to convey the order container 59 for which picking is completed to the outside to enter a next logistics procedure, such as packing. Specific extension lengths and arrangement orientations of the vacant container line 52 and the full container line 53 may be set based on an actual layout of the workstation 1. This is not specifically limited in this embodiment of this application.

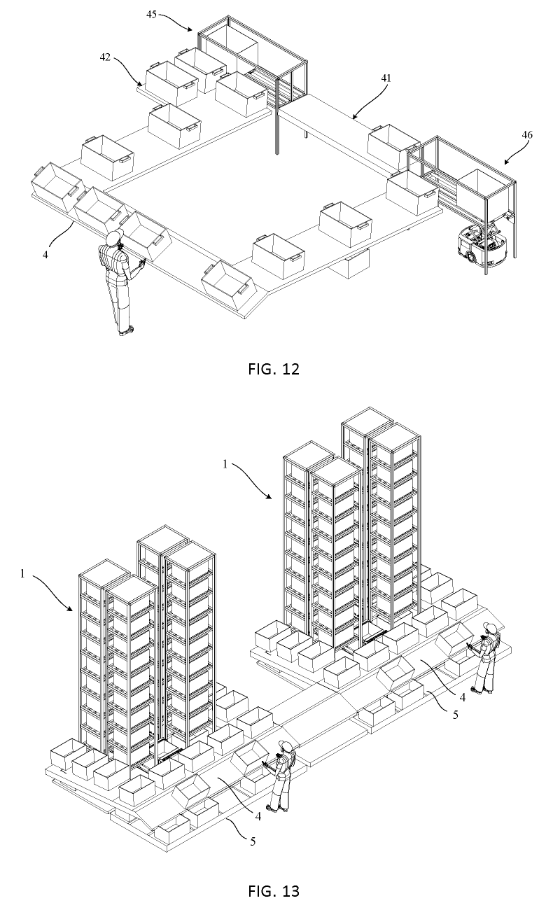

FIG. 11 is a schematic diagram 1 of a structure of a source container conveyor in a workstation according to an embodiment of this application, and FIG. 12 is a schematic diagram 2 of a structure of a source container conveyor in a workstation according to an embodiment of this application.

With reference to FIG. 2 to FIG. 12, in some embodiments, both the order container conveyor 5 and the source container conveyor 4 are U-shaped and are at least partially disposed surrounding the buffer mechanism 2. In this way, a space utilization rate of the workstation 1 can be improved, and space occupation rates of the order container conveyor 5, the source container conveyor 4, and the three-dimensional storage mechanism can be reduced.

When the order container 59 is conveyed along different directions on the order container conveyor 5, different side surfaces of the order container 59 face the conveying direction of the order container conveyor 5. When the source container 49 is conveyed along different directions on the source container conveyor 4, different side surfaces of the source container 49 face a conveying direction of the source container conveyor 4.

For example, the conveying direction of the order container conveyor 5 is parallel to the conveying direction of the source container conveyor 4. The order container conveyor 5 and the source container conveyor 4 may be disposed in a vertical direction in a layered manner, so that an occupied area of a vertical projection is reduced, thereby improving the space utilization rate.

It should be noted that a sorting position 30 is provided on a side of the sorting mechanism 3 facing away from the buffer mechanism 2. A sorting operation may be manually performed at the sorting position 30, or a sorting robot may be disposed at the sorting position 30 to perform a sorting operation. This is not specifically limited in this embodiment of this application.

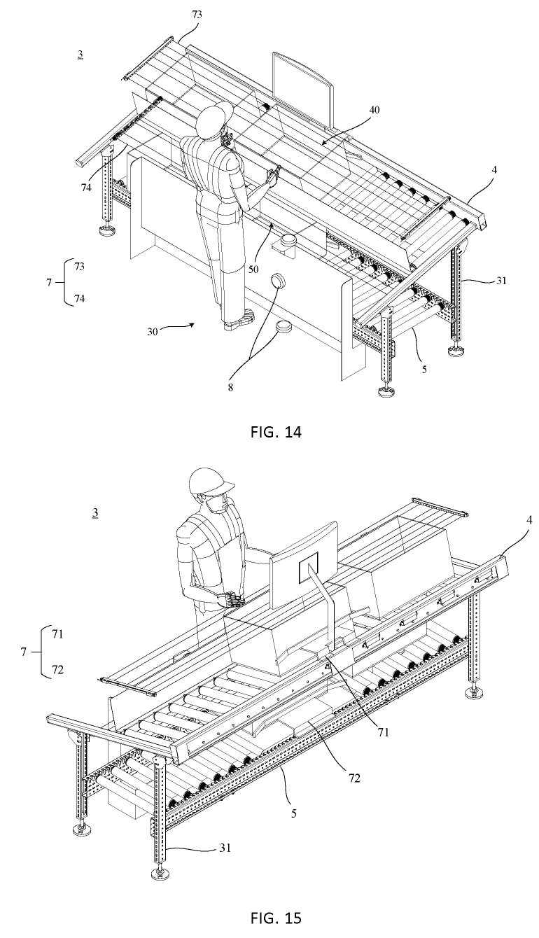

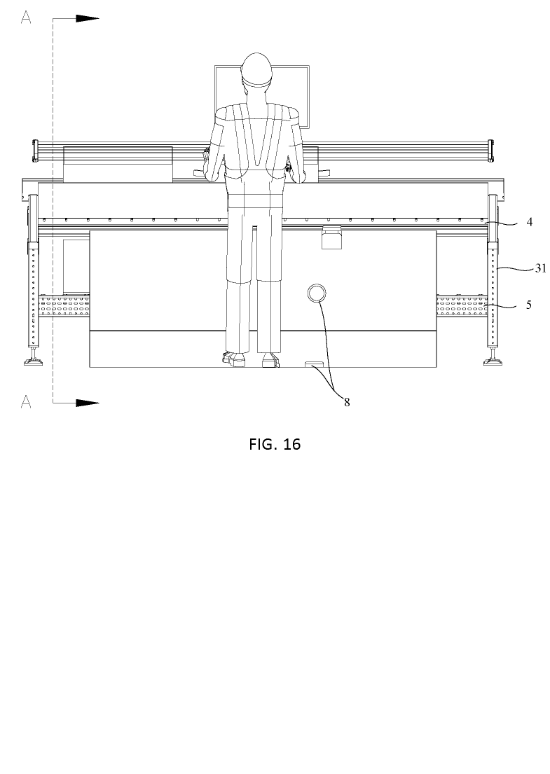

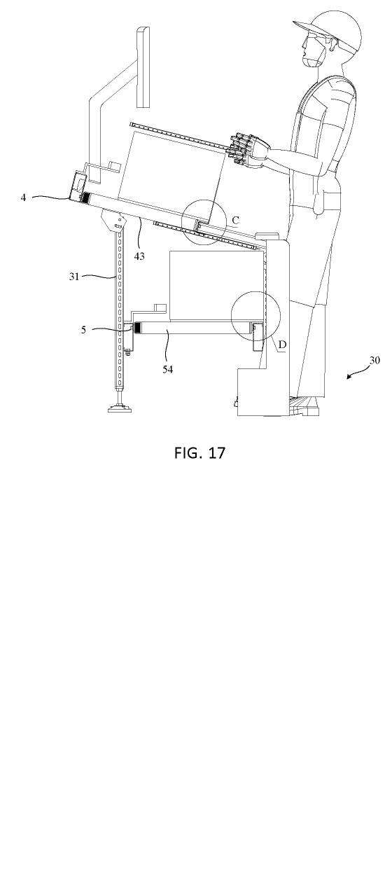

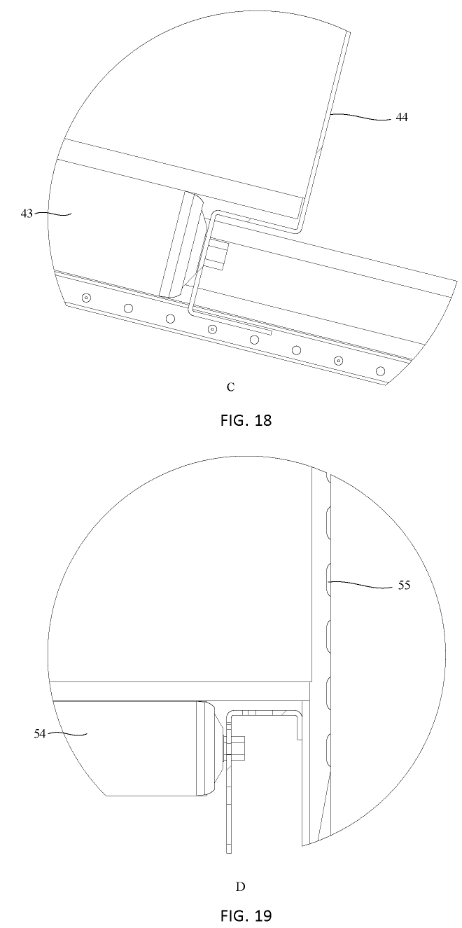

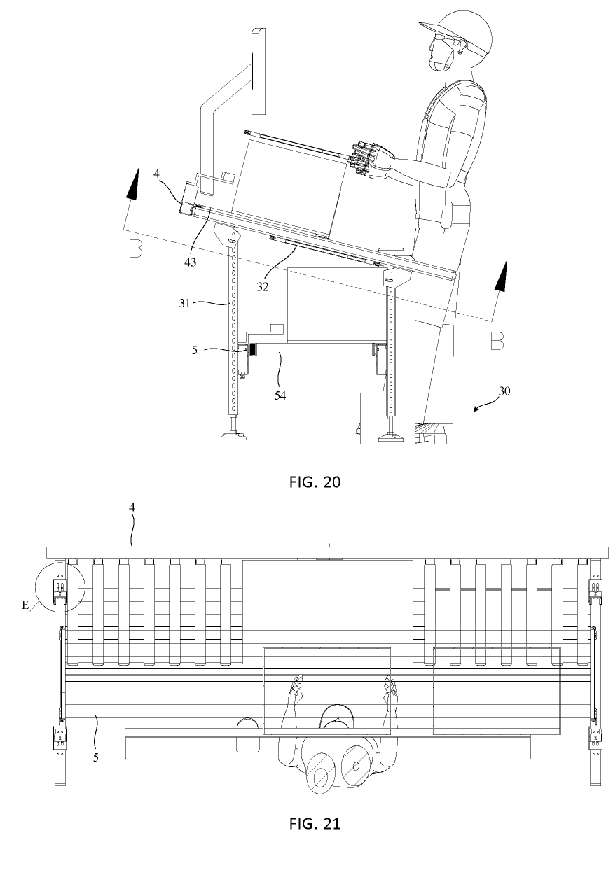

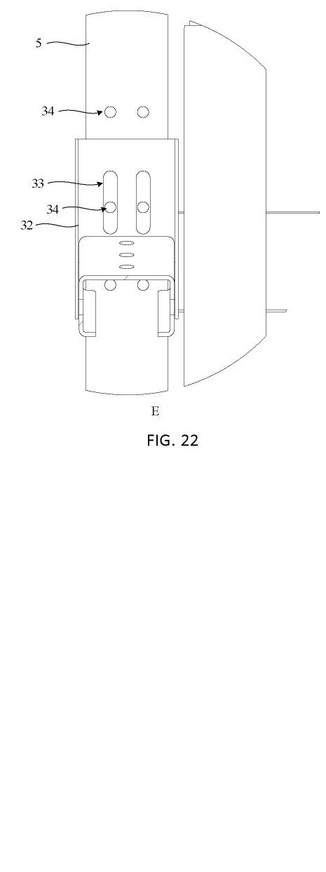

FIG. 14 is a schematic diagram 1 of a structure of a sorting mechanism according to an embodiment of this application, FIG. 15 is a schematic diagram 2 of a structure of a sorting mechanism according to an embodiment of this application, FIG. 16 is a front view of a sorting mechanism according to an embodiment of this application, FIG. 17 is a cross-sectional view taken along a direction A-A in FIG. 16, FIG. 18 is a partial view of a position C in FIG. 17, FIG. 19 is a partial view of a position D in FIG. 17, FIG. 20 is a side view of a sorting mechanism according to an embodiment of this application, FIG. 21 is a cross-sectional view taken along a direction B-B in FIG. 20, and FIG. 22 is a partial view of a position E in FIG. 21.

A specific structure of the sorting mechanism 3 is exemplarily described below.

With reference to FIG. 14 to FIG. 16, in some embodiments, the source container conveyor 4 and the order container conveyor 5 are disposed spaced away from each other in a vertical direction, and the source container conveyor 4 is located above the order container conveyor 5.

The source container conveyor 4 and the order container conveyor 5 are disposed in a staggered manner in a horizontal direction, so that a projection of the order container 59 in a vertical direction and a projection of the source container 49 in the vertical direction at least partially do not overlap. A distance between the sorting position 30 and a side of the source container conveyor 4 close to the sorting position 30 is greater than a distance between the sorting position 30 and a side of the order container conveyor 5 close to the sorting position 30.

It may be understood that when a sorting personnel or a sorting robot performs a sorting operation at the sorting position 30, the order container conveyor 5 is not blocked by the source container conveyor 4 in the vertical direction, thereby improving convenience of the sorting operation.

In some embodiments, the source container conveyor 4 has a source container inlet 45 and a source container outlet 46. The source container inlet 45 and the source container outlet 46 are respectively located at two ends of the source container conveyor 4. As shown in FIG. 12, the workstation 1 may further include a return mechanism 41. Two ends of the return mechanism 41 are respectively docked with the source container inlet 45 and a source container outlet 46.

For a source container 49 for which a sorting task is completed, if the source container 49 further retains goods, and the corresponding goods correspond to next order tasks of other order containers 49, the source container 49 may be returned from the source container outlet 46 to the source container inlet 45 by using the return mechanism 41. In this way, the source container 49 can return back to the picking position 40 along the source container conveyor 4, and the source 49 does not need to be conveyed back to an external storage device, thereby shorten a circulation path of the source container and improving logistics efficiency.

For example, a lateral side of the source container inlet 45 is provided with a return sequencing region 42, and the return sequencing region 42 is provided with a source container temporary storage position, to adjust a conveying sequence of the source container 49. In this way, the conveying sequence of the corresponding source container 49 may be adjusted based on the formed conveying sequence of the order container 59, so that conveying interruption caused by congestion of the source container 49 is avoided, thereby improving smoothness of circulation of the source container 49.

In some embodiments, the source container conveyor 4 and the order container conveyor 5 extend along a same direction, and the sorting position 30 disposed on the lateral side of the sorting mechanism 3 is opposite to the picking position 40 and the delivery position 50.

The source container conveyor 4 is obliquely disposed toward the sorting position 30 relative to the horizontal direction. Because the source container conveyor 4 is located above the order container conveyor 5, and the source container conveyor 4 is farther away from the sorting position 30, a source container 49 on the obliquely disposed source container conveyor 4 may slide toward a side close to the sorting position 30 by a distance depending on gravity. In this way, it is convenient for the sorting personnel or the sorting robot at the sorting position 30 to pick the goods from the source container.

In some embodiments, the sorting mechanism 3 may further include a plurality of support columns 31, and the order container conveyor 5 is connected between adjacent ones of the support columns 31. The source container conveyor 4 is located at a top of the support column 31 and is detachably connected to the support column 31.

For example, the support column 31 may support on a peripheral side of the source container conveyor 4 and the order container conveyor 5. End corner positions and side positions in a length direction of the source container conveyor 4 and end corner positions and side positions in a length direction of the order container conveyor 5 each may be provided with one or more support columns 31.

It should be noted that a material of the support column 31 may be metal such as iron and aluminum, an alloy, or engineering plastic with high structural strength. For example, the support column 31 may be an aluminum alloy profile. Both the source container conveyor 4 and the order container conveyor 5 may be connected to the support column 31 by using a fastener such as a bolt and a connection component such as a trigonometric bracket. A specific material type of the support column 31 is not limited in this embodiment of this application.

With reference to FIG. 17 to FIG. 22, in some embodiments, the sorting mechanism 3 may further include an adjustment member 32. The adjustment member 32 is connected to the support column 31, the source container conveyor 4 is connected to the adjustment member 32, and the adjustment member 32 is configured to adjust a position of the source container conveyor 4 relative to the order container conveyor 5.

The adjustment member 32 is provided with a first connection hole 33. The source container conveyor 4 is provided with a plurality of second connection holes 34 arranged along a width direction of the source container conveyor 4. When the first connection hole 33 is opposite to different ones of the second connection holes 34, the source container conveyor 4 is located at different positions relative to the order container conveyor 5. The sorting mechanism 3 may further include a fastener, and the fastener passes through the first connection hole 33 and is screwed to the second connection hole 34.

It may be understood that the fastener may be disassembled in different application cases, so that the first connection hole 33 is opposite to different second connection holes 34 on the source container conveyor 4, to adjust a relative position of the projection of the source container conveyor 4 in the vertical direction relative to the projection of the order container conveyor 5 in the vertical direction, that is, a size of a part of the order container not blocked by the source container in the vertical direction can be adjusted. For example, if to-be-picked goods have a large size, the source container conveyor 4 is moved toward a direction away from the sorting position 30, so that an unblocked part of the order container on the order container conveyor 5 has a larger size, thereby providing enough space to place the goods into the order container. If to-be-picked goods have a small size, the source container conveyor 4 is moved toward a direction close to the sorting position 30, so that an unblocked part of the order container on the order container conveyor 5 has a smaller size, thereby reducing an occupied area of the workstation.

In some embodiments, as shown in FIG. 17 to FIG. 20, the source container conveyor 4 may include a first conveyed member 43. One end of the first conveyed member 43 facing the sorting position 30 is provided with a first baffle 44, and there is a gap between the first baffle 44 and an end portion of the first conveyed member 43. The order container conveyor 5 may include a second conveyed member 54. One end of the second conveyed member 54 facing the sorting position 30 is provided with a second baffle 55, and there is a gap between the second baffle 55 and an end portion of the second conveyed member 54.

When the source container is located on the source container conveyor 4, at least a part of the source container is located outside a side of the first conveyed member 43 close to the sorting position 30 and abuts against the first baffle 44. When the order container is located on the order container conveyor 5, at least a part of the order container is located outside a side of the second conveyed member 54 close to the sorting position 30 and abuts against the second baffle 55.

It may be understood that the first baffle 44 is located on a side of the source container conveyor 4 closer to the sorting position 30, and the second baffle 55 is located on a side of the order container conveyor 5 closer to the sorting position 30. Therefore, both a source container at the picking position 40 and an order container at the delivery position 50 can be closer to the sorting position 30, thereby improving convenience of performing the sorting operation.

For example, a distance between the first baffle 44 and one end of the first conveyed member 43 facing the sorting position 30 may be greater than or equal to 40 mm and less than or equal to 50 mm. For example, a specific value of the distance between the first baffle 44 and the end of the first conveyed member 43 facing the sorting position 30 may include, but is not limited to, 5 mm, 10 mm, 20 mm, 30 mm, 40 mm, 41 mm, 45 mm, 49 mm, 50 mm, 60 mm, 70 mm, and the like. This is not specifically limited in this embodiment of this application.

For example, a distance between the second baffle 55 and one end of the second conveyed member 54 facing the sorting position 30 is greater than or equal to 40 mm and less than or equal to 50 mm. For example, a specific value of the distance between the second baffle 55 and the end of the second conveyed member 54 facing the sorting position 30 may include, but is not limited to, 5 mm, 10 mm, 20 mm, 30 mm, 40 mm, 41 mm, 45 mm, 49 mm, 50 mm, 60 mm, 70 mm, and the like. This is not specifically limited in this embodiment of this application.

Still with reference to FIG. 14 to FIG. 16, in some embodiments, the sorting mechanism 3 may further include a detection mechanism 7. The detection mechanism 7 is configured to detect goods sorting statuses at the picking position 40 and the delivery position 50, so that the source container is switched at the picking position 40 or the order container is switched at the delivery position 50.

It may be understood that the detection mechanism 7 may detect whether goods in the source container has been picked and may detect whether goods are placed into the order container. When it is detected that the goods in the source container at the picking position 40 have been picked, a container switching operation may be automatically performed at the picking position 40 to switch to a next source container. When it is detected that the goods are placed into the order container at the delivery position 50, a container switching operation may be automatically performed at the delivery position 50 to switch to a next order container. In this way, logistics efficiency of the sorting mechanism 3 can be improved.

For example, the detection mechanism 7 may include a first weighing unit 71. The first weighing unit 71 is disposed at the picking position 40, and the first weighing unit 71 is configured to detect weight information of the source container at the picking position 40, so that the source container is switched at the picking position 40 based on the weight information of the source container.

For example, the detection mechanism 7 may include a second weighing unit 72. The second weighing unit 72 is disposed at the delivery position 50, and the second weighing unit 72 is configured to detect weight information of the order container at the delivery position 50, so that the order container is switched at the delivery position 50 based on the weight information of the order container.

For example, the detection mechanism 7 may include a first grating unit 73. The first grating unit 73 is disposed above the picking position 40, to form a detection region above the source container at the picking position 40. The first grating unit 73 is configured to detect a goods picking action on the source container at the picking position 40, so that the source container is switched at the picking position 40 after the goods in the source container are picked.

For example, the detection mechanism 7 may include a second grating unit 74. The second grating unit 74 is disposed above the delivery position 50, to form a detection region above the order container at the delivery position 50. The second grating unit 74 is configured to detect a goods placing action on the order container at the delivery position 50, so that the order container is switched at the delivery position 50 after the goods are placed into the order container.

It should be noted that the first weighing unit 71 and the second weighing unit 72 may be pressure sensors or electronic scales using pressure sensors as main components. The first grating unit 73 and the second grating unit 74 may be infrared sensors, laser sensors, or the like. Either of the first weighing unit 71 and the first grating unit 73 may be disposed at the picking position 40, or both the first weighing unit 71 and the first grating unit 73 may be disposed at the picking position 40, to improve accuracy of a detection result. Either of the second weighing unit 72 and the second grating unit 74 may be disposed at the delivery position 50, or both the second weighing unit 72 and the second grating unit 74 may be disposed at the delivery position 50, to improve accuracy of a detection result. This is not specifically limited in this embodiment of this application.

Still with reference to FIG. 14 to FIG. 16, in some embodiments, a side of the sorting mechanism 3 facing the sorting position 30 is provided with a box switch button 8. The box switch button 8 is configured to control the source container conveyor 4 to switch the source container at the picking position 40, and/or control the order container conveyor 5 to switch the order container at the delivery position 50.

It may be understood that, when a sorting operation is performed at the sorting position 30 by a sorting personnel, the sorting person may press the box switch button 8 to perform a box switching operation after the sorting operation on goods is completed.

For example, the box switch button 8 is located at the bottom of the sorting mechanism 3, so that sorting personnel can press the box switch button 8 by using a foot. Alternatively, the box switch button 8 is located on a lateral side of the sorting mechanism 3, so that the sorting personnel can press the box switch button 8 by using a knee. In this way, an operator does not need to press the box switch button by using a hand, so that a sorting operation performed by the operator by using the hand is not affected, thereby facilitating improving sorting efficiency. For example, after picking the goods from the source container, the sorting personnel may place the goods into the order container by using the hand when pressing the box switch button 8 by using the foot or the knee to cut the source container. After placing the goods into the order container, the picking personnel may pick the goods from the source container by using the hand when pressing the box switch button 8 by using the foot or the knee to switch the order container.

In some embodiments, when the source container passes through the picking position 40, the source container continuously moves along the conveying direction of the source container conveyor 4, so that the operator at the sorting position 30 picks the goods from the source container in a process in which the source container passes through the picking position 40, thereby improving circulation efficiency of the source container. When the order container passes through the delivery position 50, the order container continuously moves along the conveying direction of the order container conveyor 5, so that the operator at the sorting position 30 places the goods into the order container in a process in which the order container passes through the delivery position 50, thereby improving circulation efficiency of the order container.

It may be understood that the corresponding source container and the corresponding order container can respectively and synchronously pass through the picking position 40 and the delivery position 50 during circulation. Alternatively, because a goods picking operation is performed before a placing operation, the order container may slightly lag behind the source container. A conveying speed of the source container along the source container conveyor 4 and a conveying speed of the order container along the order container conveyor 5 are not specifically limited in this embodiment of this application, provided that the operator or a robotic arm at the sorting position 30 can complete a picking operation within duration in which the source container passes through the picking position 40 and duration in which the order container passes through the delivery position 50.

It should be noted that the sorting position 30 has a sorting operation range, and the sorting operation range covers the picking position 40 and the delivery position 50. When the goods in the source container are not sorted to the order container and either of the source container and the order container is out of the sorting operation range, the source container conveyor 4 stops conveying the source container, and the order container conveyor 5 stops conveying the order container. For example, when a plurality of goods in one source container at the picking position 40 all need to be picked and placed into the order container at the delivery position 50, duration for performing the sorting operation at the sorting position 30 may be insufficient. In this case, the source container conveyor 4 and the order container conveyor 5 may be suspended, so that the operator or the robotic arm at the sorting position can complete the corresponding sorting operation. After the sorting operation is completed, the source container conveyor 4 and the order container conveyor 5 may be started.

It should be noted that, in the sorting mechanism provided in this embodiment of this application, through structural designs of the order container conveyor and the source container conveyor and a layout of a relative position between the order container conveyor and the source container conveyor, a path and a procedure through which the goods needs to be transported in a sorting process are shortened when a smooth and unobstructed process of sorting the goods from the source container into the order container is ensured, thereby improving the goods sorting efficiency and ensuring accuracy of the sorting process.

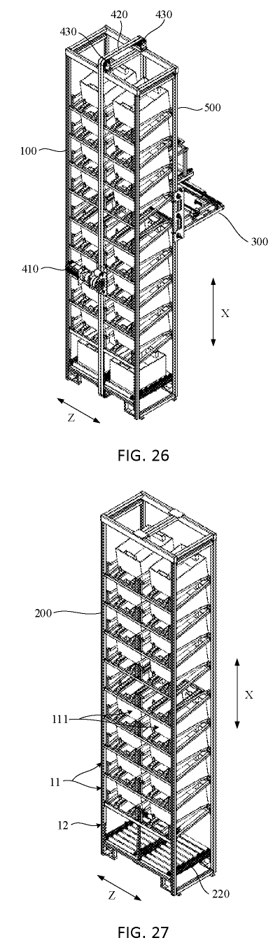

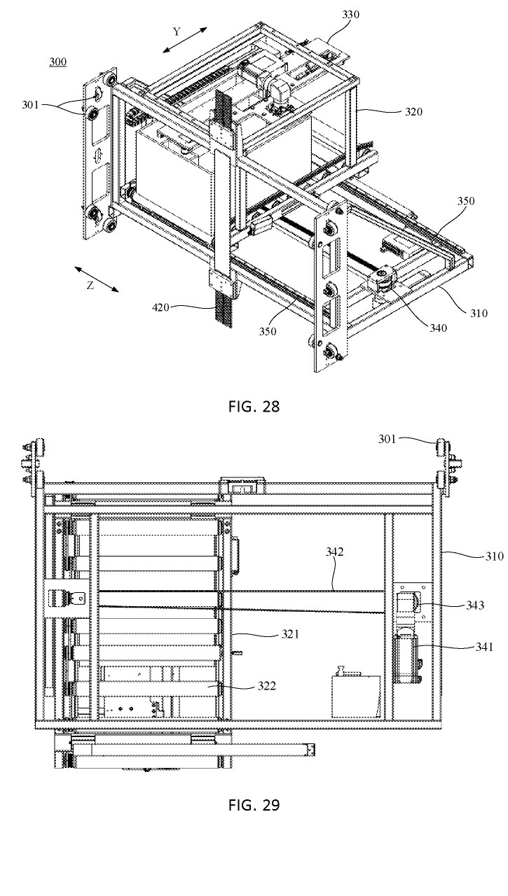

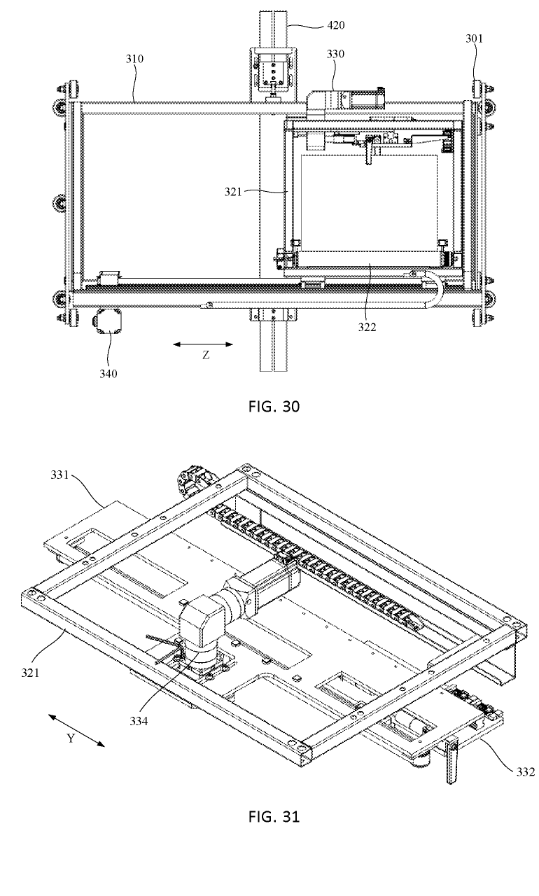

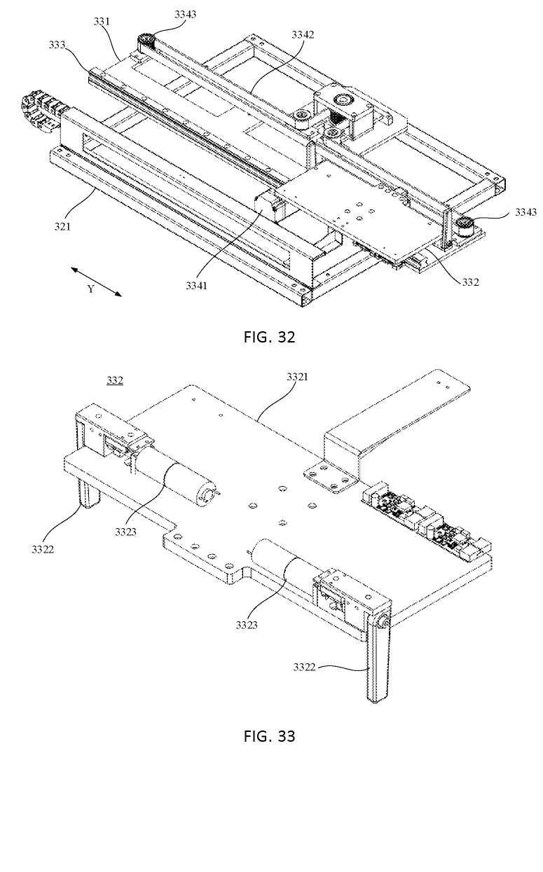

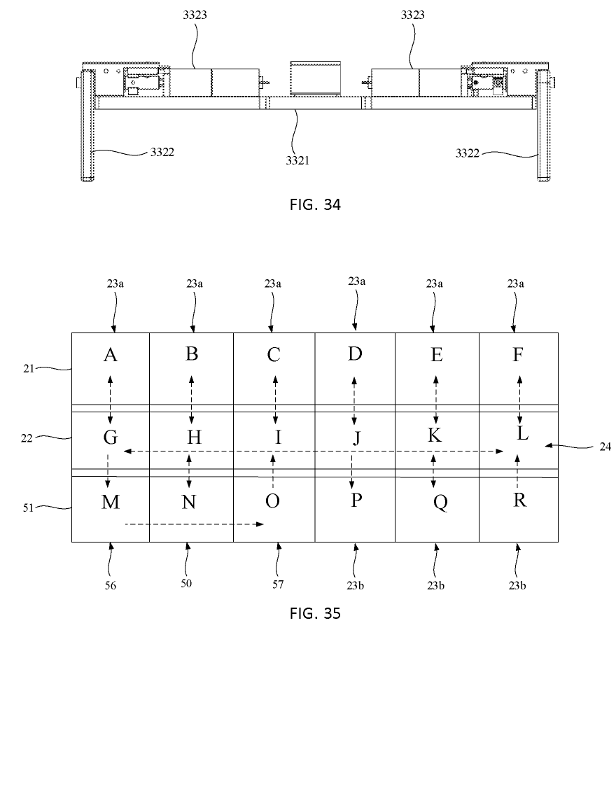

FIG. 23 is a schematic diagram of a structure of a three-dimensional storage mechanism according to an embodiment of this application, FIG. 24 is a side view of a three-dimensional storage mechanism according to an embodiment of this application, FIG. 25 is a schematic diagram 1 of cooperation between a first rack and a lifting apparatus in a three-dimensional storage mechanism according to an embodiment of this application, FIG. 26 is a schematic diagram 2 of cooperation between a first rack and a lifting apparatus in a three-dimensional storage mechanism according to an embodiment of this application, FIG. 27 is a schematic diagram of a structure of a second rack in a three-dimensional storage mechanism according to an embodiment of this application, FIG. 28 is a schematic diagram of a structure of a lifting apparatus in a three-dimensional storage mechanism according to an embodiment of this application, FIG. 29 is a bottom view of a lifting apparatus in a three-dimensional storage mechanism according to an embodiment of this application, FIG. 30 is a front view of a lifting apparatus in a three-dimensional storage mechanism according to an embodiment of this application, FIG. 31 is a schematic diagram 1 of a structure of a picking and placing assembly in a three-dimensional storage mechanism according to an embodiment of this application, FIG. 32 is a schematic diagram 2 of a structure of a picking and placing assembly in a three-dimensional storage mechanism according to an embodiment of this application, FIG. 33 is a schematic diagram of a structure of a telescopic member in a three-dimensional storage mechanism according to an embodiment of this application, and FIG. 34 is a front view of a telescopic member in a three-dimensional storage mechanism according to an embodiment of this application.

A specific structure of the three-dimensional storage mechanism is described in detail below.

With reference to FIG. 23 to FIG. 27, an embodiment of this application provides a three-dimensional storage mechanism 10. The three-dimensional storage mechanism 10 includes a first rack 100, a second rack 200, and a lifting apparatus 300. The first rack 100 and the second rack 200 are configured to store goods, and the lifting apparatus 300 can pick the goods (such as the goods contained in an order container) from the first rack 100 or the second rack 200 and place the goods onto the first rack 100 or the second rack 200. The first rack 100 and the second rack 200 are disposed spaced away from each other, and a lifting channel 13 extending along a first direction exists between the first rack 100 and the second rack 200. The lifting apparatus 300 is located in the lifting channel 13, and the lifting apparatus 300 can move along the lifting channel 13.

The first direction may be a vertical direction, the lifting channel 13 extends along the vertical direction, and the lifting apparatus 300 can move in a lifting manner along the first direction, in other words, the lifting apparatus 300 can move in the lifting manner along a height direction of the first rack 100 and the second rack 200. The lifting apparatus 300 may be movably connected to at least one of the first rack 100 and the second rack 200, so that the lifting apparatus 300 climbs and moves along the lifting channel 13 between the first rack 100 and the second rack 200.

In some embodiments, the first rack 100 and the second rack 200 each include a plurality of storage layers 11 and at least one conveying layer 12 that are arranged along the first direction. The conveying layer 12 is configured to receive the goods from a side facing away from the lifting channel 13 or convey the goods to the side facing away from the lifting channel 13.

It may be understood that the conveying layer 12 may be any layer on the first rack 100 and the second rack 200, and the side of the conveying layer 12 facing away from the lifting channel 13 may be an outlet or an inlet of the goods. The three-dimensional storage mechanism 10 in this embodiment of this application can receive, through the conveying layer 12, the goods conveyed by an external device, or convey the goods stored on the first rack 100 and the second rack 200 to another external device through the conveying layer 12.

For example, the lifting apparatus 300 may be docked to the first rack 100, and a small gap may exist between a side of the lifting apparatus 300 facing away from the first rack 100 and a side of the second rack 200 facing the lifting channel 13. Alternatively, the lifting apparatus 300 may be docked to the second rack 200, and a small gap may exist between a side of the lifting apparatus 300 facing away from the second rack 200 and a side of the first rack 100 facing the lifting channel 13. Alternatively, opposite sides of the lifting apparatus 300 may be respectively docked to the first rack 100 and the second rack 200, and a width of the lifting apparatus 300 may match a width of the lifting channel 13.

It should be noted that, in the three-dimensional storage mechanism 10 provided in this embodiment of this application, the lifting channel 13 is formed between the first rack 100 and the second rack 200, and the lifting apparatus 300 is used to move in the lifting channel 13 to pick and place the goods. In addition, the racks may directly receive or convey the goods through the conveying layer 12. When an area occupied by the three-dimensional storage mechanism 10 is small, goods inbound and outbound efficiency in the three-dimensional storage mechanism 10 is improved, and efficiency per square meter of the three-dimensional storage mechanism 10 is improved. Certainly, more racks may be disposed in the three-dimensional storage mechanism 10, as long as the lifting apparatus 300 is disposed between two adjacent racks. A specific quantity of the racks is not limited in this embodiment of this application. Two racks are used as an example for description below, and details are not described again.

In addition, a layer height of the storage layer 11 of the first rack 100 and a layer height of the storage layer 11 of the second rack 200 may be equal. The conveying layer 12 of the first rack 100 and the conveying layer 12 of the second rack 200 may be located at the bottom, the middle, or the top, and the conveying layer 12 of the first rack 100 and the conveying layer 12 of the second rack 200 may have a same height in the first direction. For example, both the conveying layer 12 of the first rack 100 and the conveying layer 12 of the second rack 200 are disposed at the bottom of the racks. Alternatively, the conveying layer 12 of the first rack 100 and the conveying layer 12 of the second rack 200 have different heights in the first direction, provided that the side of the conveying layer 12 facing away from the lifting channel 13 of the first rack 100 and a side of the second rack 200 facing away from the lifting channel 13 are conveniently docked to external devices. For example, the side of the conveying layer 12 facing away from the lifting channel 13 may be docked to an external conveyor or an external transport robot.

The first direction is defined as a direction X, and the first direction is the height direction of the first rack 100 and the second rack 200. A second direction is defined as a direction Y, and the second direction is a width direction of the lifting channel 13. A third direction is defined as a direction Z, and the third direction is a direction perpendicular to a plane XY.

First, a specific inbound and outbound manner and procedure of the three-dimensional storage mechanism 10 are described in detail below.

Still With reference to FIG. 23 to FIG. 27, in some embodiments, when the lifting apparatus 300 moves along the lifting channel 13 to be opposite to any storage layer 11, the lifting apparatus 300 may pick the goods from the storage layer 11 or place the goods onto the storage layer 11. When the lifting apparatus 300 moves along the lifting channel 13 to be opposite to the conveying layer 12, the lifting apparatus 300 is configured to convey the goods to the conveying layer 12 or receive the goods on the conveying layer 12. In this way, the lifting apparatus 300 may be used to pick the goods on the storage layer 11 and convey the goods through the conveying layer 12 or store the goods on the conveying layer 12 onto the storage layer 11, thereby improving the inbound and outbound efficiency of the goods.

It may be understood that, in an outbound procedure, the lifting apparatus 300 may move along the lifting channel 13 to a storage layer 11 on which target goods are located and pick the target goods from the storage layer 11. Subsequently, the lifting apparatus 300 may move along the lifting channel 13 to be opposite to the conveying layer 12. The conveying layer 12 may be the conveying layer 12 of the first rack 100 or may be the conveying layer 12 of the second rack 200, and the lifting apparatus 300 may place the target goods onto the conveying layer 12. Subsequently, the conveying layer 12 may convey the target goods to the side facing away from the lifting channel 13, to complete an outbound operation of the three-dimensional storage mechanism 10.

In an inbound procedure, upstream goods may be conveyed to the conveying layer 12 by using a device such as a conveyor or a transport robot. The conveying layer 12 may be the conveying layer 12 of the first rack 100 or may be the conveying layer 12 of the second rack 200. Subsequently, the lifting apparatus 300 may move along the lifting channel 13 to be opposite to the conveying layer 12, and the conveying layer 12 may autonomously convey the goods to the lifting apparatus 300, or the lifting apparatus 300 may pick the goods from the conveying layer 12. Subsequently, the lifting apparatus 300 may move along the lifting channel 13 to be opposite to a target storage layer 11 and place the goods onto the target storage layer 11.

To further improve the inbound and outbound efficiency, the foregoing outbound procedure and inbound procedure may be performed simultaneously. The conveying layer 12 of the first rack 100 and the conveying layer 12 of the second rack 200 are located at a same height. When the lifting apparatus 300 moves to a height position of the conveying layers 12, two sides of the lifting apparatus 300 respectively correspond to the conveying layer 12 of the first rack 100 and the conveying layer 12 of the second rack 200.

In some embodiments, the conveying layer 12 of the first rack 100 has a first conveyor 110, the conveying layer 12 of the second rack 200 has a second conveyor 220, and a conveying direction of the first conveyor 110 and a conveying direction of the second conveyor 220 are the same. One of the first conveyor 110 and the second conveyor 220 is configured to receive goods from the side facing away from the lifting channel 13, and the other of the first conveyor 110 and the second conveyor 220 is configured to convey the goods to the side facing away from the lifting channel 13.

It may be understood that both the first conveyor 110 and the second conveyor 220 may be unidirectional conveyors, where one of the two conveyors is responsible for an inbound operation, and the other is responsible for an outbound operation, so that efficiency that the goods enter the racks may be improved in a unidirectional conveying manner.

For example, the first conveyor 110 and the second conveyor 220 are opposite to each other. When the lifting apparatus 300 moves between the first conveyor 110 and the second conveyor 220, the first conveyor 110, the second conveyor 220, and the lifting apparatus 300 jointly form an inbound and outbound channel 14, so that inbound and outbound operations can be synchronously performed on warehoused goods, thereby improving logistics efficiency.

Descriptions are provided below by using an example in which the first conveyor 110 is responsible for the inbound operation and the second conveyor 220 is responsible for the outbound operation.

When the outbound procedure and the inbound procedure are performed simultaneously, the lifting apparatus 300 may pick outbound goods from the storage layer 11, the second conveyor 220 simultaneously receives inbound goods conveyed from the outside, and the goods waits on the second conveyor 220 for the inbound operation. Subsequently, the lifting apparatus 300 moves along the lifting channel 13 to be opposite to the two conveying layers 12. When the lifting apparatus 300 conveys the outbound goods to the first conveyor 110, the second conveyor 220 conveys the inbound goods to the lifting apparatus 300. Subsequently, the first conveyor 110 may convey the outbound goods to an external device, and the lifting apparatus 300 may simultaneously move along the lifting channel 13 and place the inbound goods into the target storage layer 11. The foregoing process is repeated, so that the three-dimensional storage mechanism 10 can implement continuous and synchronous inbound and outbound operations.

It should be noted that the inbound and outbound channel 14 may extend along the second direction, in other words, the inbound and outbound channel 14 extends along the direction Y. The second direction is perpendicular to the first direction, the first direction is the vertical direction, and the inbound and outbound channel 14 extends along the horizontal direction. The three-dimensional storage mechanism 10 may perform inbound and outbound operations on the goods along the horizontal direction through the conveying layer 12, so that the racks can be docked to an apparatus such as an external conveyor.

A specific driving structure for the lifting apparatus 300 to move along the lifting channel 13 is described in detail below.

Refer to FIG. 28 to FIG. 30 and with reference to FIG. 23 to FIG. 27, in some embodiments, the three-dimensional storage mechanism 10 may further include a first driving assembly 400. The first driving assembly 400 may be disposed on either of the first rack 100 and the second rack 200. The first driving assembly 400 is configured to drive the lifting apparatus 300 to move along the lifting channel 13, thereby improving movement efficiency of the lifting apparatus 300 along the lifting channel 13.

It may be understood that the first driving assembly 400 may be disposed on the first rack 100 or the second rack 200, a rack on which the first driving assembly 400 is disposed is an active rack, and a rack on which no first driving assembly 400 is disposed is a passive rack. Alternatively, the first rack 100 and the second rack 200 each are provided with one first driving assembly 400, to synchronously drive the lifting apparatus 300. This is not specifically limited in this embodiment of this application. Detailed descriptions are provided below by using an example in which the first driving assembly 400 is disposed on the first rack 100.

In some embodiments, the first driving assembly 400 may include a first driving unit 410, a first flexible transmission member 420, and a plurality of first transmission wheels 430. The plurality of first transmission wheels 430 are respectively disposed at two ends of the first rack 100 along the first direction. The first flexible transmission member 420 is disposed surrounding the plurality of first transmission wheels 430. The first driving unit 410 is disposed on the first rack 100 and configured to drive the first flexible transmission member 420 to transmit along the first direction. The lifting apparatus 300 is connected to the first flexible transmission member 420, such that the lifting apparatus 300 is driven by using the first flexible transmission member 420, so as to perform a lifting movement.

It may be understood that the plurality of first transmission wheels 430 may be divided into four groups, and each of the groups has at least one first transmission wheel 430. The four groups of first transmission wheels 430 may respectively be disposed on beams on two sides of the top of the first rack 100 and beams on two sides of the bottom of the first rack 100. In this way, when being disposed surrounding the plurality of first transmission wheels 430, the first flexible transmission member 420 can form a closed circle surrounding the first rack 100. For example, with reference to FIG. 24, when the first flexible transmission member 420 is transmitted anticlockwise, the lifting apparatus 300 ascends; and when the first flexible transmission member 420 is transmitted clockwise, the lifting apparatus 300 descends, thereby improving movement smoothness of the lifting apparatus 300 along the lifting channel 13.

In addition, the first driving unit 410 may be disposed on a side of the first rack 100 facing away from the lifting channel 13, and the plurality of first transmission wheels 430 disposed at the top and the bottom of the first rack 100 are driven wheels. A driving wheel may be connected to an output end of the first driving unit 410, and the first driving unit 410 may provide power for transmission of the first flexible transmission member 420 by using the driving wheel. The first driving unit 410 is disposed on the side facing away from the lifting channel 13, so that the first driving unit 410 does not occupy space in the lifting channel 13, and the lifting apparatus 300 can fully use the space in the lifting channel 13, thereby improving the efficiency per square meter of the three-dimensional storage mechanism 10.

For example, the first driving unit 410 may be an electric motor. An output end of the electric motor may be provided with a decelerator. The first flexible transmission member 420 may be a flexible component such as a belt, a synchronous belt, a steel wire rope, or a chain. Correspondingly, the first transmission wheel 430 may be a transmission wheel such as a belt wheel, a synchronous wheel, a steel wire reel, or a chain wheel. This is not specifically limited in this embodiment of this application. The output end of the first driving unit 410 is provided with the driving wheel. The first flexible transmission member 420 may surround and pass through the drive wheel. In addition, a pinch roller may be disposed on a side of the first flexible transmission member 420 facing away from the driving wheel. The pinch roller may be located to ensure that the first flexible transmission member 420 is always in effective contact with the driving wheel, to avoid slipping, thereby ensuring accuracy of a movement position of the lifting apparatus 300.

In some embodiments, the three-dimensional storage mechanism 10 may further include a first guide rail 500. The first guide rail 500 is disposed on the first rack 100, and the first guide rail 500 extends along the first direction. The lifting apparatus 300 is movably connected to the first guide rail 500, so that movement stability of the lifting apparatus 300 along the lifting channel 13 can be improved.

It may be understood that the first guide rail 500 may extend along the direction X, and a length of the first guide rail 500 may match a height of the first rack 100. The first guide rail 500 may be connected to an edge column on a side of the first rack 100 facing the lifting channel 13, or the first guide rail 500 may be formed on the edge column on the side of the first rack 100 facing the lifting channel 13. This is not specifically limited in this embodiment of this application.

There may be two first guide rails 500. The two first guide rails 500 are respectively located on two sides of the first rack 100. Both the two first guide rails 500 extend along the direction X and are parallel to each other. Both two sides of the lifting apparatus 300 facing the first rack 100 are respectively movably connected to the two first guide rails 500. The lifting apparatus 300 may be slidably connected to the first guide rail 500 by using a slide block or may be in rolling connection to the first guide rail 500 by using a roller. This is not specifically limited in this embodiment of this application.

For example, the lifting apparatus 300 may include at least two guide wheel groups, and the at least two guide wheel groups are respectively disposed opposite to the two first guide rails 500. With reference to FIG. 28, each of the guide wheel groups may include a plurality of guide wheels 301. The plurality of guide wheels 301 respectively abut against different sides of the guide rail. For example, wheel axles of a part of the guide wheels 301 are parallel to the direction X, and wheel axles of a part of the guide wheels 301 are parallel to the direction Z, so that the lifting apparatus 300 can be maintained to abut against the first guide rail 500, thereby avoiding sway generated by the lifting apparatus 300 relative to the first guide rail 500.

It should be noted that each of the guide wheel groups may be provided with three guide wheels 301, each side of the lifting apparatus 300 may be provided with two guide wheel groups arranged along the direction X, and an independent guide wheel 301 may be provided between the two guide wheel groups. In this way, each side of the lifting apparatus 300 is provided with at least seven guide wheels 301 cooperating with the first guide rail 500, to ensure that the lifting apparatus 300 can tightly clamp the first guide rail 500 by using the guide wheels 301, thereby improving lifting movement stability of the lifting apparatus 300.

A specific structure of the lifting apparatus 300 is described in detail below.

Still with reference to FIG. 23 to FIG. 30, in some embodiments, the lifting apparatus 300 may include a lifting body 310, a side shift assembly 320, and a picking and placing assembly 330. The lifting body 310 is movably connected to at least one of the first rack 100 and the second rack 200.

A structure in which the lifting body 310 is movably connected to the first rack 100 and the second rack 200 is the same as the foregoing manner in which the lifting apparatus 300 is movably connected to the first guide rail 500. Details are not described herein again.

It may be understood that the storage layer 11 has a plurality of storage positions 111 arranged along the third direction, the side shift assembly 320 is movably connected to the lifting body 310, and the side shift assembly 320 is movable relative to the lifting body 310 along the third direction, so that the side shift assembly 320 is opposite to different storage positions 111, and the picking and placing assembly 330 is connected to the side shift assembly 320. Therefore, a warehousing density of the three-dimensional storage mechanism 10 can be improved, and the picking and placing assembly 330 can pick and place goods at the different storage positions 111.

For example, the storage positions 111 of each storage layer 11 are arranged along the direction Z, and each storage layer 11 may have two, three, four, or more storage positions 111. This is not specifically limited in this embodiment of this application. Each storage position 111 is obliquely disposed inward the storage position 111 relative to the horizontal direction, thereby preventing goods stored in the storage position 111 from sliding out. In addition, the bottom of each storage position 111 may support the goods by using a drum. Therefore, when the goods are dragged and picked from the storage position 111, or when the goods are placed into the storage position 111, friction between the goods and the bottom of the storage position 111 can be reduced, thereby improving smoothness of the goods when the goods are picked from and placed into the storage position 111.

A specific driving structure of the side shift assembly 320 in the lifting apparatus 300 is described in detail below.

Still with reference to FIG. 23 to FIG. 30, in some embodiments, the lifting apparatus 300 may further include a second driving assembly 340 and a second guide rail 350. The second guide rail 350 is connected to the lifting body 310 and extends along the third direction. The side shift assembly 320 is slidably connected to the second guide rail 350. The second driving assembly 340 is disposed in the lifting body 310, and the second driving assembly 340 is configured to drive the side shift assembly 320 to move along the second guide rail 350.

It may be understood that the second guide rail 350 extends along the direction Z. The second guide rail 350 may provide guiding and supporting for movement of the side shift assembly 320 relative to the lifting body 310. There may be a plurality of second guide rails 350, including but not limited to, two, three, or more second guide rails 350, thereby improving movement stability of the side shift assembly 320 relative to the lifting body 310.

In some embodiments, as shown in FIG. 29, the second driving assembly 340 may include a second driving unit 341, a second flexible transmission member 342, and a plurality of second transmission wheels 343. The plurality of second transmission wheels 343 are respectively disposed at two ends of the lifting body 310 along the third direction. The second flexible transmission member 342 is disposed surrounding the plurality of second transmission wheels 343. The second driving unit 341 is configured to drive the second flexible transmission member 342 to transmit along the third direction. The side shift assembly 320 is connected to the second flexible transmission member 342, thereby improving movement smoothness of the side shift assembly 320 relative to the lifting body 310.

There may be two second transmission wheels 343. The two second transmission wheels 343 may be respectively disposed at the two ends of the lifting body 310. One of the two second transmission wheels 343 may be a driving wheel, and the other may be a driven wheel. The driving unit may be disposed with the driving wheel on a same side of the lifting body 310 and drive the driving wheel to rotate.

For example, the second driving unit 341 may be an electric motor. An output end of the electric motor may be provided with a decelerator. The second flexible transmission member 342 may be a flexible component such as a belt, a synchronous belt, a steel wire rope, or a chain. Correspondingly, the second transmission wheel 343 may be a transmission wheel such as a belt wheel, a synchronous wheel, a steel wire reel, or a chain wheel. This is not specifically limited in this embodiment of this application.

When the side shift assembly 320 moves on the lifting body 310 to be opposite to an opening of a corresponding target storage position 111, picking and placing operations may be completed on the goods by using the picking and placing assembly 330 disposed on the side shift assembly 320. A specific structure of the picking and placing assembly 330 is described in detail below.

Refer to FIG. 31 and FIG. 32 and with reference to FIG. 23 to FIG. 30, in some embodiments, the picking and placing assembly 330 may include a fixing member 331, a telescopic member 332, a third guide rail 333, and a third driving assembly 334. The fixing member 331 is connected to the side shift assembly 320. The third guide rail 333 is connected to the fixing member 331. The telescopic member 332 is movably connected to the third guide rail 333. The third driving assembly 334 is disposed at the fixing member 331, and the third driving assembly 334 is configured to drive the telescopic member 332 to perform bidirectional telescopic movement relative to the fixing member 331, so that the telescopic member 332 picks and places goods from the first rack 100 or the second rack 200.

It may be understood that the telescopic member 332 is moveable relative to the fixing element 331 along the direction Y, the third guide rail 333 may extend along the direction Y, the telescopic member 332 may be slidably connected to the third guide rail 333 by using a slide block, and the third guide rail 333 provides guiding for the movement of the telescopic member 332 relative to the fixing element 331.

The telescopic member 332 is moveable forward or backward relative to the fixing member 331 along the direction Y, to implement bidirectional telescoping. Therefore, the goods can be picked from and placed into both the first rack 100 and the second rack 200 through the movement of the telescopic member 332, thereby reducing production costs and improving the inbound and outbound efficiency.

For example, the fixing element 331 may be a plate-shaped structure disposed at the top of the side shift assembly 320. The telescopic member 332 is a telescopic arm having a goods picking structure. The telescopic arm is provided with a goods picking element such as a joint finger or a suction cup and is configured to cooperate with the goods or a material box at the storage position 111 to implement a goods picking operation.

In some embodiments, as shown in FIG. 32, the third driving assembly 334 may include a third driving unit 3341, a third flexible transmission member 3342, and a plurality of third transmission wheels 3343. The plurality of third transmission wheels 3343 are respectively disposed at two ends of the fixing member 331. The third flexible transmission member 3342 is disposed surrounding the plurality of third transmission wheels 3343. The third driving unit 3341 is configured to drive the third flexible transmission member 3342 to transmit along a goods picking and placing direction of the picking and placing assembly 330. The telescopic member 332 is connected to the third flexible transmission member 3342, to improve movement smoothness and stability of the telescopic member 332 relative to the fixing member 331.

It may be understood that there may be two third transmission wheels 3343. The two third transmission wheels 3343 may be disposed at two ends of the fixing member 331 along the direction Y. The third driving unit 3341 may be disposed at a middle position of the fixing member 331. The two third transmission wheels 3343 may be transmission wheels. An output end of the third driving unit 3341 may be provided with a driving wheel. The driving wheel may engage with the third flexible transmission member 3342 to drive the third flexible transmission member 3342 to transmit along the direction Y. In addition, pinch rollers may be disposed on two sides of the driving wheel, and tightly press the third flexible transmission member 3342 on a side of the third flexible transmission member 3342 facing away from the driving wheel, so that sliding and misplacement between the driving wheel and the third flexible transmission member 3342 are avoided, thereby improving position precision when the telescopic member 332 moves relative to the fixing member 331 to pick and place the goods.

For example, the third driving unit 3341 may be an electric motor. An output end of the electric motor may be provided with a decelerator. The third flexible transmission member 3342 may be a flexible component such as a belt, a synchronous belt, a steel wire rope, or a chain. Correspondingly, the third transmission wheel 3343 may be a transmission wheel such as a belt wheel, a synchronous wheel, a steel wire reel, or a chain wheel. This is not specifically limited in this embodiment of this application.

The goods picking structure on the telescopic member 332 is described in detail below.

Refer to FIG. 33 and FIG. 34 and with reference to FIG. 23 to FIG. 30, in some embodiments, the telescopic member 332 may include a telescopic body 3321, an abutment member 3322, and a fourth driving unit 3323. The abutment member 3322 is rotatably connected to the telescopic body 3321. The fourth driving unit 3323 is configured to drive the abutment member 3322 to rotate relative to the telescopic body 3321, so that the goods can be picked and placed in a pushing and pulling manner, thereby improving goods inbound and outbound efficiency.

It may be understood that the abutment member 3322 may be rod-shaped, so that the abutment member 3322 rotates relative to the telescopic body 3321 to form a finger joint structure. Using a material box as an example, when the telescopic member 332 extends relative to the fixing element 331 to pick the goods, during extending of the telescopic member 332, the abutment member 3322 is horizontally disposed, to avoid interference with the material box. When the telescopic member 332 extends to a preset position, the abutment member 3322 rotates relative to the telescopic body 3321, so that the abutment member 3322 is vertically disposed. In this way, when the telescopic member 332 retracts relative to the fixing element 331, the abutment member 3322 can abut against an inner side wall of the material box and drag the material box out of the storage position 111. When the telescopic member 332 telescopes relative to the fixing element 331 to place the goods, the abutment member 3322 can abut against an outer side wall of the material box and push the material box to move to the storage position 111. Details are not described herein.

For example, there may be two abutment members 3322. The two abutment members 3322 are respectively disposed at two ends of the telescopic body 3321 along the goods picking and placing direction of the picking and placing assembly 330. The two abutment members 3322 may be respectively configured for goods picking and placing on the first rack 100 and the second rack 200, thereby improving the goods inbound and outbound efficiency. In addition, the two abutment members 3322 may be separately driven by one fourth driving unit 3323, and the fourth driving unit 3323 may be an electric motor disposed on the telescopic member 332.

In this embodiment of this application, the side shift assembly 320 may include a side shift bracket 321 and a conveying mechanism 322. The conveying mechanism 322 is disposed at the bottom of the side shift bracket 321, and the picking and placing assembly 330 is disposed at the top of the side shift bracket 321. The conveying mechanism 322 is configured to support the goods, and the conveying mechanism 322 is configured to drive the goods to move into or out of the side shift assembly 320, so that the conveying mechanism 322 can provide a driving force for the goods to move into and out of the side shift assembly 320, thereby improving the goods inbound and outbound efficiency.

For example, a conveying structure may include a plurality of driving rollers. When the goods are moved into the side shift assembly 320 or are moved out of the side shift assembly 320, the driving rollers may rotate clockwise or anticlockwise, so that friction between the driving rollers and the bottom of the goods drives the goods to move.

It should be noted that the three-dimensional storage mechanism provided in this embodiment of this application includes the first rack, the second rack, and the lifting apparatus. The first rack and the second rack are disposed spaced away from each other, and there is the lifting channel extending along the first direction between the first rack and the second rack. The lifting apparatus is located in the lifting channel, the lifting apparatus is movable along the lifting channel, and ethe first rack and the second rack each include the plurality of storage layers and the at least one conveying layer that are arranged along the first direction. The conveying layer is configured to receive the goods from the side facing away from the lifting channel or convey the goods to the side facing away from the lifting channel. Therefore, when the area occupied by the three-dimensional storage mechanism is small, the goods inbound and outbound efficiency in the three-dimensional storage mechanism is improved, thereby improving the efficiency per square meter of the three-dimensional storage mechanism.

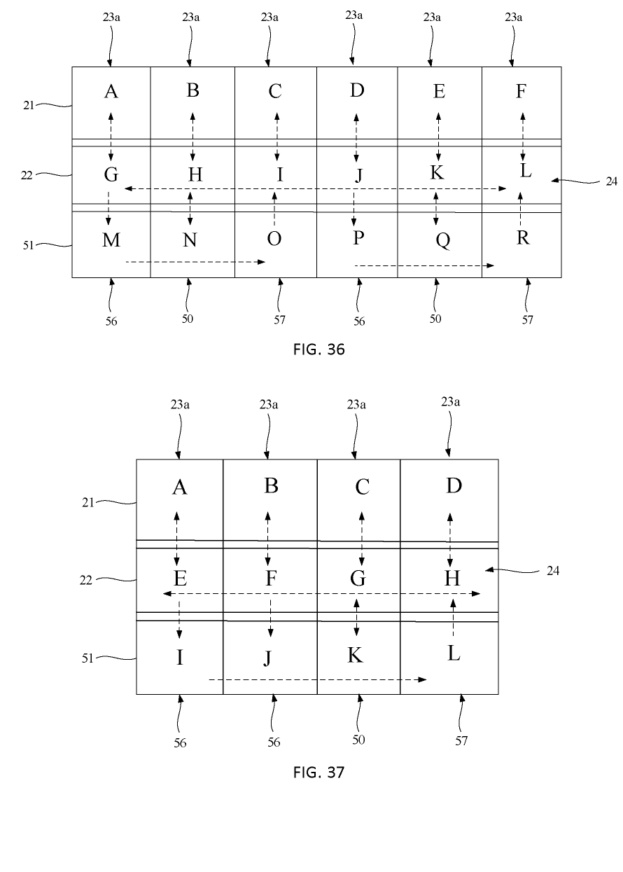

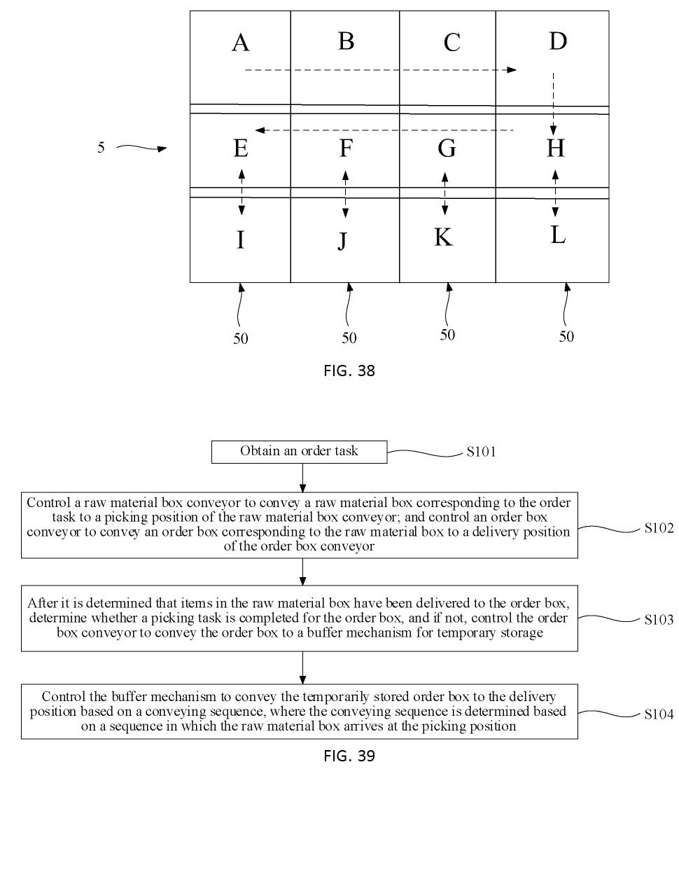

FIG. 35 is a schematic diagram of a first structure of a planar storage mechanism according to an embodiment of this application, FIG. 36 is a schematic diagram of a second structure of a planar storage mechanism according to an embodiment of this application, FIG. 37 is a schematic diagram of a third structure of a planar storage mechanism according to an embodiment of this application, and FIG. 38 is a schematic diagram of a fourth structure of a planar storage mechanism according to an embodiment of this application.

A specific structure of the planar storage mechanism 20 and a specific coordination manner between the planar storage mechanism 20 and the order container conveyor 5 are described in detail below.

Refer to FIG. 35 and with reference to FIG. 1 to FIG. 7, in the workstation provided in this embodiment of this application, the planar storage mechanism 20 is located on a lateral side of an order container conveyor 5. The planar storage mechanism 20 includes the candidate channel 21 and the queuing channel 22. The candidate channel 21 is configured to buffer an order container for which a picking task is incomplete, and the order container in the candidate channel 21 is configured to first pass through the queuing channel 22 and then enter the order container conveyor 5.

It may be understood that, when the order container for which the picking task is incomplete is stored in the candidate channel 21, the order container conveyor 5 performs a picking operation on another order container, and the order container for which the picking task is incomplete does not need to stop on the order container conveyor 5 to wait, so that the order container conveyor 5 can maintain performing continuous picking operations, thereby improving logistics efficiency. The queuing channel 22 is used as a transition between the candidate channel 21 and the order container conveyor 5 and can adjust sequencing positions of an order container entering and leaving the order container conveyor 5 and an order container entering and leaving the candidate channel 21 may be adjusted, to ensure smoothness of circulation of the order container between different channels based on the conveying sequence.

In some embodiments, the queuing channel 22 may include a plurality of transfer positions 24. Transfer mechanisms are disposed at the transfer positions 24. An order container at the transfer position 24 may be delivered between adjacent ones of the transfer positions 24. Alternatively, the order container at the transfer position 24 may be moved into or out of the queuing channel 22 by using the transfer mechanism.

The queuing channel 22 has a conveying line conveying the order container along a length direction of the queuing channel 22, such as a conveying belt or a conveying roller. Delivery of the order container between different transfer positions 24 inside the queuing channel 22 may be implemented by using the conveyor. When an order container needs to be moved into and out of the queuing channel 22, the transfer mechanism located at the corresponding transfer position 24 may be used for implementation.

For example, the transfer mechanism may be a structure, such as a push plate, a suction cup, or a gripper claw, that is driven by a power unit, such as an electric motor or a cylinder. A specific structure type of the transfer mechanism is not limited in this embodiment of this application.

Still refer to FIG. 35 and with reference to FIG. 1 to FIG. 7, in some embodiments, the candidate channel 21 may include a plurality of first temporary storage positions 23a, and the plurality of first temporary storage positions 23a are sequentially arranged, along the length direction of the queuing channel 22, on a side of the queuing channel 22 facing away from the order container conveyor 5. The plurality of first temporary storage positions 23a are disposed in one-to-one correspondence with the plurality of transfer positions 24.

Each of the first temporary storage positions 23a may store at least one order container for which a picking task is incomplete. Order containers at different first temporary storage positions 23a may be moved in or out by using transfer mechanisms at temporary storage positions opposite to the order containers in the queuing channel 22.

For example, the order container conveyor 5 has a picking channel 51. The candidate channel 21, the queuing channel 22, and the picking channel 51 are parallel to each other. A direction in which the transfer mechanism moves an order container into or out of the transfer position 24 is perpendicular to a direction of the queuing channel 22. In other words, a direction in which the transfer mechanism drives the order container to move is perpendicular to the length direction of the queuing channel 22.

A specific order container temporary storage manner of the planar storage mechanism 20 is described in detail below by using different specific examples.

With reference to FIG. 35, in some embodiments, the candidate channel 21 may further include at least one second temporary storage position 23b. The second temporary storage position 23b is located on the same side of the queuing channel 22 with the order container conveyor 5, and the second temporary storage position 23b and the order container conveyor 5 are opposite to different transfer positions 24.

It may be understood that there are at least two rows of temporary storage positions in the candidate channel 21. At least one of the rows includes first temporary storage positions 23a, and at least one of the rows includes second temporary storage positions 23b. The first temporary storage positions 23a and the second temporary storage positions 23b are respectively arranged on two sides of the queuing channel 22. In this way, when a length of the picking channel 51 of the order container conveyor 5 is less than a length of the queuing channel 22, remaining space of the queuing channel 22 facing the order container conveyor 5 can be utilized, thereby improving space utilization while increasing an order container storage capacity of the candidate channel 21.

It should be noted that the picking channel 51 is parallel to the queuing channel 22. The picking channel 51 includes a queuing position 56, a return position 57, and at least one delivery position 50. A source container conveyor 4 has at least one picking position 40. When a source container arrives at the picking position 40, to-be-sorted goods in the source container are picked and placed into an order container at the delivery position 50.

The queuing position 56 is configured to receive an order container outputted at the transfer position 24, or receive a vacant order container and deliver the order container to the delivery position 50. The return position 57 is configured to receive an order container outputted at the delivery position 50 and deliver the order container to the queuing channel 22.

In addition, the order container may alternatively be directly conveyed between the delivery position 50 and the queuing channel 22. To be specific, a transfer position 24 opposite to the delivery position 50 may directly receive an order container at the delivery position 50 or deliver an order container to the delivery position 50. A specific order container conveying path may be designed based on the conveying sequence of the order container during queuing, and details are not described herein.

For example, in the figure, A, B, C, D, E, and F are the first temporary storage positions 23a of the candidate channel 21, P, Q, and R are the second temporary storage positions 23b of the candidate channel 21, G, H, I, J, K, and L are the transfer positions 24 of the queuing channel 22, M is the queuing position 56, N is the delivery position 50, and O is the return position 57.

With reference to FIG. 36, in some embodiments, the picking channel 51 may include a plurality of delivery positions 50. The plurality of delivery positions 50 are disposed spaced away from each other along the length direction of the queuing channel 22. The plurality of delivery positions 50 are respectively opposite to different transfer positions 24. Two sides of each of the delivery positions 50 are provided with the queuing position 56 and the return position 57.

It may be understood that the plurality of delivery positions 50 may perform sorting simultaneously on a same side of the queuing channel 22, and the conveying sequence of order containers that need to be sorted at different delivery positions 50 may be adjusted in the queuing channel 22.

For example, A, B, C, D, E, and F are the first temporary storage positions 23a of the candidate channel 21, and G, H, I, J, K, and L are the transfer positions 24 of the queuing channel 22. M, N, and Q are in one group, where M is the queuing position 56, N is the delivery position 50, and O is the return position 57. P, Q, and R are in one group, where P is the queuing position 56, Q is the delivery position 50, and R is the return position 57.

With reference to FIG. 37, in some embodiments, there may be a plurality of queuing positions 56. The plurality of queuing positions 56 are sequentially arranged on a same side of the delivery position 50, and the plurality of queuing positions 56 are respectively opposite to different transfer positions 24.

It may be understood that order containers at the plurality of queuing positions 56 may flow sequentially into the delivery positions 50 along a conveying direction of the order container conveyor 5, so that a plurality of order containers may be pre-arranged in the picking channel 51 on the order container conveyor 5. Not only an order container for which a sorting task is incomplete and that is delivered from the transfer positions 24 can be arranged, but also a vacant order container can be arranged.

For example, A, B, C, and D are the first temporary storage positions 23a of the candidate channel 21, E, F, G, and H are the transfer positions 24 of the queuing channel 22, I and J are the queuing positions 56, K is the delivery position 50, and L is the return position 57.

With reference to FIG. 38, in some embodiments, the order container conveyor 5 may include a plurality of delivery positions 50. The plurality of delivery positions 50 are sequentially arranged on a lateral side of the order container conveyor 5 along the transmission direction of the order container conveyor 5. At least a part of the plurality of delivery positions 50 are used as temporary storage positions.

It may be understood that, when corresponding orders or batch orders in order containers at the part of the delivery positions 50 are multi-line orders, after current sorting tasks of the order containers are completed, the order containers may stop at the delivery positions 50 to wait, and the order containers are outputted until all order sorting tasks corresponding to the order containers are completed. In this way, there may be another delivery position 50 for another order container to perform a sorting task.

For example, labels A, B, C, D, E, F, G, H are the order container conveyors 5, the order container may be moved from D to H by using the transfer mechanism, and I, J, K, and L are four delivery positions 50.

It should be noted that, one of the foregoing plurality of docking and arrangement manners of the planar storage mechanism 20 and the order container conveyor 5 may be used, or a plurality of the foregoing docking and arrangement manners may be used in combination. This is not specifically limited in this embodiment of this application.

The workstation 1 provided in this embodiment of this application may further include a vacant container line 52 and a full container line 53. The vacant container line 52 is docked to at least one of the order container conveyors 5 and the queuing channel 22. The full container line 53 is docked to at least one of the order container conveyors 5 and the queuing channel 22.

An embodiment of this application provides a warehousing system. The warehousing system includes a storage rack, a workstation, and a carrying mechanism. The storage rack is configured to store a source container. The workstation is configured to sort goods in the source container to the order container. The carrying mechanism is configured to carry a to-be-sorted source container from the storage rack to the workstation, or carry a sorted source container from the workstation to the storage rack.

FIG. 13 is a schematic diagram of cooperation between a plurality of workstations according to an embodiment of this application.

For example, with reference to FIG. 13, in the warehousing system, there may be a plurality of workstations 1, and source container conveyors 4 of adjacent ones of the workstations 1 communicate with each other. Order container conveyors 5 of the adjacent ones of the workstations communicate with each other. In this way, at least one of a source container and an order container may circulate with each other between the adjacent ones of the workstations 1.

It should be noted that the warehousing system may include all technical solutions and technical effects of the foregoing workstation, sorting mechanism, and three-dimensional storage mechanism. Details are not described herein again.

A method for controlling workstation is described in detail below.

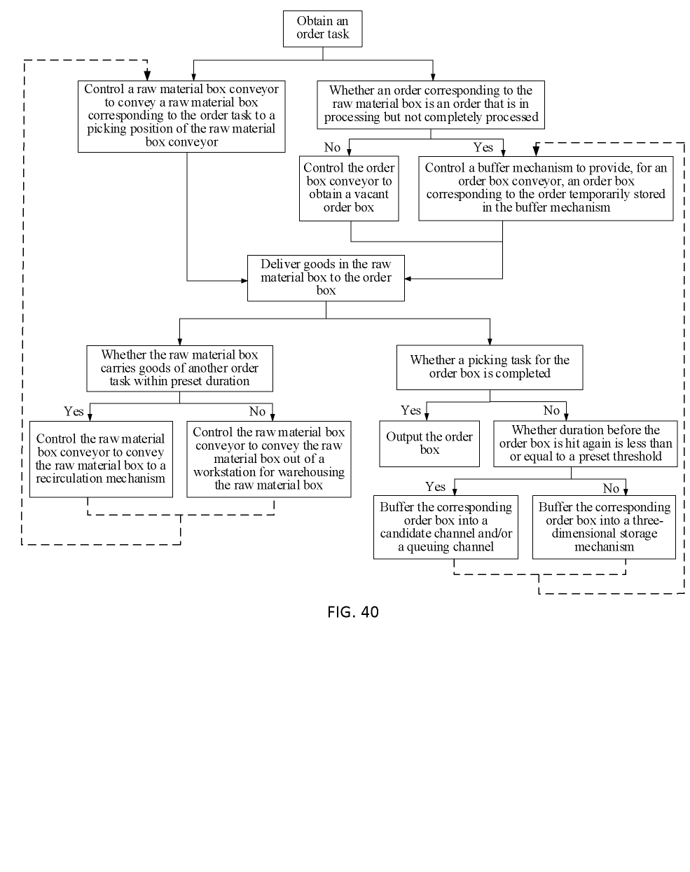

FIG. 39 is a schematic diagram of steps of a method for controlling workstation according to an embodiment of this application, and FIG. 40 is a specific flowchart of the method for controlling workstation according to an embodiment of this application.

Refer to FIG. 39 and FIG. 40 and with reference to FIG. 1 to FIG. 38, an embodiment of this application provides a method for controlling workstation. The method is performed by a controller of a workstation, and includes:

S101: Obtain an order task.

The order task may be obtained from a control center of a warehousing system. Each obtained order task may correspond to one order number. Each order number corresponds to one mapping table of goods information. The mapping table of the goods information stores addresses of goods corresponding to the order.

S102: Control a source container conveyor to convey a source container corresponding to the order task to a picking position of the source container conveyor; control an order container conveyor to convey an order container corresponding to the source container to a delivery position of the order container conveyor.

To-be-sorted goods corresponding to each order task may be stored in one or more source containers. When performing sorting of an order task, the workstation selects an order container to correspond to the order task.

The controller of the workstation may respectively send a control instruction to the source container conveyor and the order container conveyor. A conveying task performed by the source container conveyor on the source container and a conveying task performed by the order container conveyor on the order container may be simultaneously performed.

In some embodiments, the step of controlling an order container conveyor to convey an order container corresponding to the source container to a delivery position of the order container conveyor further includes:

determining whether an order corresponding to the source container is an order that is in processing but not completely processed; and if yes, controlling a buffer mechanism to provide, for the order container conveyor, an order container corresponding to the order and temporarily stored in the buffer mechanism; or if not, controlling the order container conveyor to obtain a vacant order container and convey the vacant order container to the delivery position for processing the order.

S103: After it is determined that items in the source container have been delivered to the order container, determine whether a picking task is completed for the order container, and if not, control the order container conveyor to convey the order container to the buffer mechanism for temporary storage.

When the buffer mechanism includes a planar storage mechanism and a three-dimensional storage mechanism, duration before an order container that passes through the delivery position but for which picking is incomplete is hit again is determined.

If the duration before the order container is hit again is less than or equal to a preset threshold, the corresponding order container is buffered into a candidate channel and/or a queuing channel; or if the duration before the order container is hit again is greater than the preset threshold, the corresponding order container is buffered into the three-dimensional storage mechanism.

It may be understood that, if all the picking tasks of the order container are completed, the order container does not enter the buffer mechanism, but flows directly out of the workstation through the order container conveyor, to complete an outbound operation.

In some embodiments, after it is determined that items in the source container have been delivered to the order container, the method further includes:

determining whether the source container carries goods of another order task within preset duration, and if yes, controlling the source container conveyor to convey the source container to a return mechanism; or if not, controlling the source container conveyor to convey the source container out of the workstation for warehousing the source container.

S104: Control the buffer mechanism to convey the temporarily stored order container to the delivery position based on a conveying sequence, where the conveying sequence is determined based on a sequence in which the source container arrives at the picking position.

It should be noted that, after an order picking task is completed for an order container picked from the buffer mechanism, whether all the picking tasks are completed is determined again. If all the picking tasks are completed, the order container may directly flow out of the workstation to a next process. If the picking tasks corresponding to the order container are still not completed, the order container may be conveyed to the buffer mechanism again for buffering, that is, step S103 and step S104 are repeated until all the picking tasks corresponding to the order container are completed.

A method for controlling workstation in an order processing process is described below.

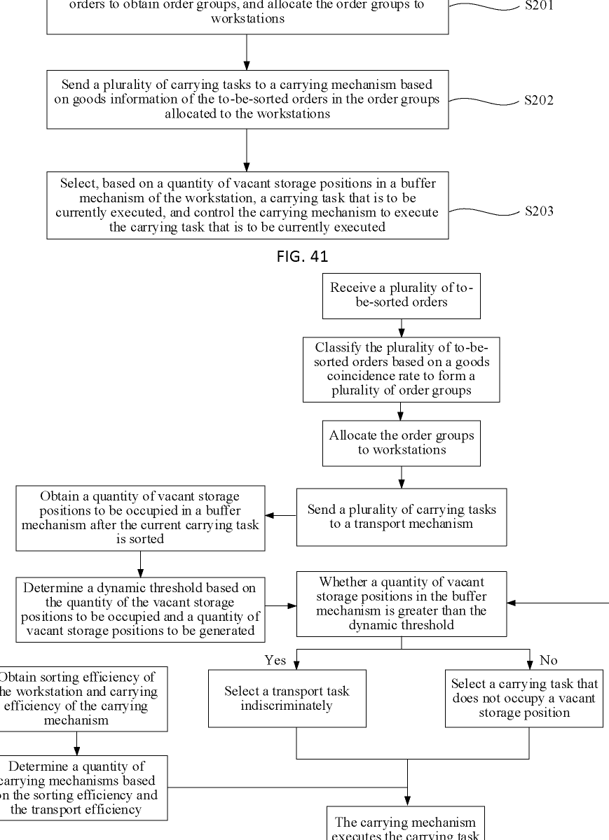

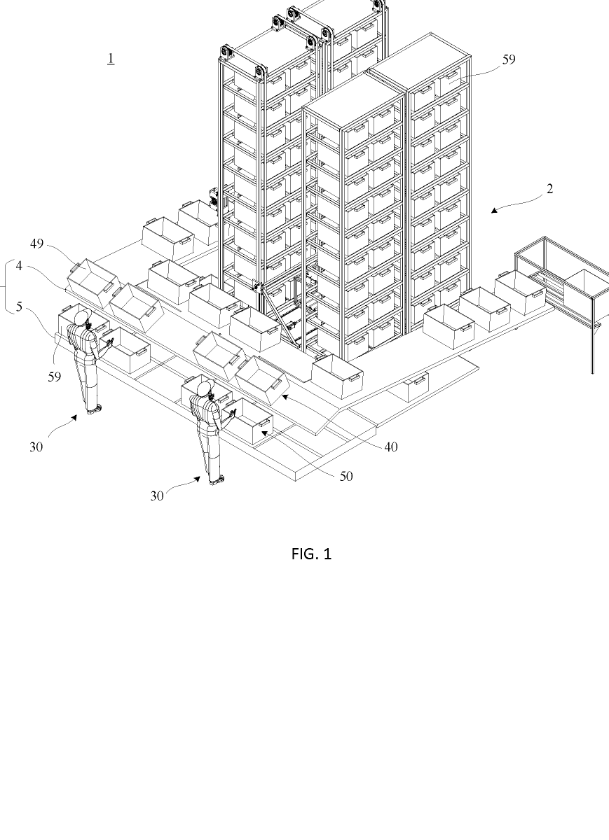

FIG. 41 is a schematic diagram of steps of an order processing method according to an embodiment of this application, and FIG. 42 is a specific flowchart of the order processing method according to an embodiment of this application.

Refer to FIG. 41 and FIG. 42 and with reference to FIG. 1 to FIG. 38, an embodiment of this application provides an order processing method. The method is performed by a processor, and includes:

S201: Receive a plurality of to-be-sorted orders, group the to-be-sorted orders to obtain order groups, and allocate the order groups to workstations.

One of the order groups includes one or more orders. For example, the plurality of to-be-sorted orders may be classified based on a goods coincidence rate to form a plurality of order groups, and orders in a same order group are allocated to a same workstation.

It may be understood that the goods coincidence rate refers to a coincidence rate that target goods of different orders are located in a same source container or in source containers at close storage positions. A controller of the workstation may preset a threshold of the goods coincidence rate. For example, the goods coincidence rate is 40%, 50%, 60%, 70%, 80%, or the like. This is not specifically limited in this embodiment of this application. When the goods coincidence rate of the received plurality of orders reaches or exceeds the threshold, the corresponding plurality of orders are allocated to form an order group.

It should be noted that a warehousing system may be provided with a plurality of workstations, and orders in one order group are allocated to a same workstation, thereby improving order processing efficiency. In addition, when a source container corresponding to the orders in the order group is carried, a quantity of carrying times can be reduced, and a carrying path can be shortened, thereby improving logistics efficiency.

S202: Send a plurality of carrying tasks to a carrying mechanism based on goods information of the to-be-sorted orders in the order groups allocated to the workstations.

A carrying mechanism may be a transport robot or another movable automatic carrying device. The controller of the workstation may send a control instruction to the carrying device through wireless communication. Each control instruction may include one or more carrying tasks.

In some embodiments, the send a plurality of carrying tasks to a carrying mechanism based on goods information of the to-be-sorted orders in the order groups allocated to the workstations may include the following steps:

Step 1: Obtain an average line-to-order ratio and an average order coincidence rate of all current orders of the workstations.

Step 2: Determine a quantity of the carrying tasks based on a quantity, the average line-to-order ratio, and the average order coincidence rate of the orders of the workstations.

The quantity of the carrying tasks may be calculated according to a formula M = N * R * α. M is the quantity of the carrying tasks, N is the quantity of the orders, R is the average line-to-order ratio, and α is the average order coincidence rate. The average line-to-order ratio is an average value of line-to-order ratios of all the orders. For example, a line-to-order ratio of a single line of orders is 1, and a line-to-order ratio of two lines of orders is 2. The average order coincidence rate is an average goods coincidence rate of all the orders.

S203: Select, based on a quantity of vacant storage positions in a buffer mechanism of the workstation, a carrying task that is to be currently executed, and control the carrying mechanism to execute the carrying task that is to be currently executed, where the buffer mechanism is configured to store an order container for which a picking task is incomplete.

It may be understood that the quantity of the vacant storage positions in the buffer mechanism dynamically changes as a sorting task of the workstation is performed. The controller of the workstation may obtain and monitor the quantity of the vacant storage positions in the buffer mechanism in real time, select a carrying task based on a real-time value of the quantity of the vacant storage positions, and send the selected carrying task to the carrying mechanism in a form of a control instruction.

In some embodiments, the select a carrying task that is to be currently executed based on a quantity of vacant storage positions in a buffer mechanism of the workstation may include the following steps:

determining whether the quantity of the vacant storage positions in the buffer mechanism is greater than a dynamic threshold, and if yes, selecting a carrying task indiscriminately, or if not, selecting a carrying task that does not occupy a vacant storage position.

In this way, when the quantity of the vacant storage positions is greater than the dynamic threshold, it indicates that there are sufficient vacant storage positions in the buffer mechanism to store a new order container. Therefore, the carrying task can be selected indiscriminately. When the quantity of the vacant storage positions is less than or equal to the dynamic threshold, it indicates that the quantity of the vacant storage positions in the buffer mechanism is insufficient. If the order container corresponding to the selected carrying task occupies a new storage position, the buffer mechanism may be full and out of storage space. Therefore, in this case, the carrying task that does not occupy the vacant storage position is selected, so that sustained and stable operation of the workstation can be maintained, and a risk that the buffer mechanism is out of storage space can be avoided.

It should be noted that the dynamic threshold may be a preset value in the controller of the workstation, and may be set or adjusted based on a specific logistics rate of the workstation. A specific value of the dynamic threshold is not limited in this embodiment of this application.

In some embodiments, when the order is a single-line single-piece order, a plurality of single-line single-piece orders are combined into a batch order, and the batch order is processed as one order. The batch order includes a single-line batch order and a multi-line batch order.

For example, the carrying task that does not occupy the vacant storage position may include a carrying task corresponding to a single-line multi-piece order or the single-line batch order, and carrying tasks corresponding to a last line and a middle line of a multi-line order or the multi-line batch order.

It may be understood that the single-line single-piece order refers to that the order has only one piece of target goods. The single-line multi-piece order refers to that the order has a plurality of target goods, and the plurality of target goods can be sorted by using only a single sorting operation. For example, the plurality of target goods are located in a same source container.

In some embodiments, the determine whether the quantity of the vacant storage positions in the buffer mechanism is greater than a dynamic threshold may specifically include the following steps:

Step 1: Obtain a quantity of vacant storage positions to be occupied in the buffer mechanism after the current carrying task is sorted and a quantity of vacant storage positions to be generated.

Step 2: Determine the dynamic threshold based on the quantity of the vacant storage positions to be occupied and the quantity of the vacant storage positions to be generated.

For example, the determine the dynamic threshold based on the quantity of the vacant storage positions to be occupied and the quantity of the vacant storage positions to be generated specifically includes:

determining the dynamic threshold according to a formula S – T = Q, where S is the quantity of the vacant storage positions to be occupied in the buffer mechanism after the current carrying task is sorted, T is the quantity of the vacant storage positions to be generated after the current carrying task is sorted, and Q is the dynamic threshold.

After the carrying mechanism is controlled to execute the carrying task that is to be currently executed, the order processing method provided in this embodiment of this application further includes the following steps:

If the carrying task is a carrying task corresponding to a single-line multi-piece order or a single-line batch order, the workstation is controlled to obtain a vacant order container, and after all goods corresponding to the single-line multi-piece order or the single-line batch order are delivered to the order container, the workstation is controlled to convey the order container to a workstation outlet.

A picking task for the single-line multi-piece order or the single-line batch order can be completed busing only one picking operation, and no temporary storage is required. The workstation outlet refers to a downstream outlet of an order conveyor along a conveying direction of the order conveyor. An order container flowing out through the workstation outlet may enter a next logistics procedure, such as packaging.

It may be understood that the multi-line order or the multi-line batch order may include the 1^{st} line and a last line, or include the 1^{st} line, a middle line, and a last line. When picking is performed for an order, each line of the order corresponds to a carrying task, and carrying tasks corresponding to the 1^{st} line, the middle line, and the last line can be executed sequentially.

For example, when a multi-line order or a multi-line batch order includes a first line, a second line, a third line, and a fourth line that correspond to four carrying tasks. The first line is the 1^{st} line, the second line and the third line are the middle lines, and the fourth line is the last line.

If the carrying task is a carrying task corresponding to a last line of a multi-line order or a multi-line batch order, the workstation is controlled to obtain an order container corresponding to the multi-line order or the multi-line batch order from the buffer mechanism, and after goods corresponding to the last line are delivered to the order container, the workstation is controlled to convey the order container to the workstation outlet.

If the carrying task is a carrying task corresponding to a middle line of a multi-line order or a multi-line batch order, the workstation is controlled to obtain an order container corresponding to the multi-line order or the multi-line batch order from the buffer mechanism, and after goods corresponding to the middle line are delivered to the order container, the workstation is controlled to convey the order container to the buffer mechanism for buffering.

If the carrying task is a carrying task corresponding to the 1^{st} line of a multi-line order or a multi-line batch order, the workstation is controlled to obtain a vacant order container, and after goods corresponding to the 1^{st} line are delivered to the order container, the workstation is controlled to convey the order container to the buffer mechanism for buffering.

In some embodiments, before the plurality of carrying tasks are sent to the carrying mechanism based on the goods information of the to-be-sorted orders in the workstations, the method may further include the following steps:

Step 1: Obtain sorting efficiency of the workstation and carrying efficiency of the carrying mechanism.

Step 2: Determine a quantity of carrying mechanisms based on the sorting efficiency and the carrying efficiency.

It may be understood that the carrying mechanism may have different types, and different similar carrying mechanisms may have different carrying efficiency. When the quantity of the carrying mechanisms is determined based on the sorting efficiency and the carrying efficiency, a combination of different carrying mechanisms may be used.

For example, average duration for which the source container stops at the picking position for goods picking is 6s, in other words, the workstation consumes one source container every 6s. Therefore, the carrying mechanism needs to complete one carrying task within 6s. Carrying efficiency of a first carrying mechanism is 80 boxes/h, in other words, 45s/box. Carrying efficiency of a second carrying mechanism is 20 boxes/h, in other words, 180s/box. To satisfy the rate of 6s/box of the workstation, 7.5 first carrying mechanisms and 30 second carrying mechanisms are required. In an actual process, 8 first carrying mechanisms and 30 second carrying mechanisms are allocated to satisfy a source container requirement of the workstation. A specific source container consumption rate of the workstation and the carrying efficiency of the carrying mechanism are not specifically limited in this embodiment of this application.

It should be noted that, in the order processing method provided in this embodiment of this application, a corresponding carrying task may be selected based on a dynamic change of the quantity of the vacant storage positions in the buffer mechanism, so that a risk that the buffer mechanism is out of storage space in a goods sorting process can be avoided, to ensure sustained and high-efficiency operation of a goods outbound sorting procedure, thereby improving goods sorting efficiency.

An embodiment of this application further provides a storage medium. The storage medium stores computer-executable instructions. When being executed, the computer-executable instructions are used to implement the method for controlling workstation in the foregoing technical solution. When being executed, the computer-executable instructions are used to implement the order processing method in the foregoing technical solution.

The storage medium may be a computer-readable storage medium, or may be a communication medium. The communication medium includes any medium that facilitates transmission of a computer program from one place to another. The computer-readable storage medium may be any available medium that can be accessed by a general-purpose or special-purpose computer. For example, the computer-readable storage medium is coupled to a processor, so that the processor can read information from the computer-readable storage medium and write information into the computer-readable storage medium. Certainly, the computer-readable storage medium may alternatively be a component of the processor. The processor and the computer-readable storage medium may be located in an application specific integrated circuit (Application Specific Integrated Circuit, ASIC). In addition, the ASIC may be located in a user equipment. In addition, the processor and the computer-readable storage medium may alternatively exist in a communication device as discrete components.

For example, the storage medium may be implemented by any type of volatile or non-volatile storage device or a combination thereof, such as a static random access memory (Static Random Access Memory, SRAM), an electrically-erasable programmable read-only memory (Electrically-Erasable Programmable Read-Only Memory, EEPROM), an erasable programmable read-only memory (Erasable Programmable Read-Only Memory, EPROM), a programmable read-only memory (Programmable Read-Only Memory, PROM), a read-only memory (Read-Only Memory, ROM), a magnetic memory, a flash memory, a magnetic disk, or an optical disc. The storage medium may be any available medium that can be accessed by a general-purpose or special-purpose computer.

It should be noted finally that the foregoing embodiments are merely used for describing the technical solutions of this application, and are not intended to limit them. Although this application has been described in detail with reference to the foregoing embodiments, a person of ordinary skill in the art should understand that they may still make modifications to the technical solutions described in the foregoing embodiments or make equivalent replacements to some or all of the technical features therein. However, such modifications or replacements do not cause the essence of the corresponding technical solutions to depart from the scope of the technical solutions of the embodiments of this application.

1. A workstation, comprising:
a sorting mechanism comprising:
a source container conveyor, configured to convey a source container, wherein the source container is configured to store to-be-sorted goods, and the source container conveyor has a picking position; and
an order container conveyor, configured to convey an order container, wherein the order container is configured to receive goods sorted from the source container, and the order container conveyor has a delivery position; and when the source container arrives at the picking position, the to-be-sorted goods in the source container are picked and placed into an order container at the delivery position; and
a buffer mechanism located on a lateral side of the sorting mechanism, and configured to buffer an order container for which a picking task is incomplete, and convey the order container to the delivery position based on a conveying sequence, wherein the conveying sequence is determined based on a sequence in which the source container arrives at the picking position.

2. The workstation according to claim 1, wherein the buffer mechanism comprises at least one of a three-dimensional storage mechanism and a planar storage mechanism.

3. The workstation according to claim 2, wherein the three-dimensional storage mechanism comprises a rack, and the rack comprises a storage layer and a conveying layer that are arranged in a vertical direction; and the storage layer is configured to temporarily store the order container for which the picking task is incomplete, and the conveying layer is configured to dock with the order container conveyor.

4. The workstation according to claim 3, wherein the conveying layer has an inbound port and an outbound port, the outbound port is configured to dock with an upstream section of the order container conveyor, the inbound port is configured to dock with a downstream section of the order container conveyor.

5. The workstation according to claim 4, wherein two ends of the order container conveyor along a conveying direction each are provided with a transfer mechanism, and the transfer mechanisms at the two ends of the order container conveyor are respectively corresponding to the inbound port and the outbound port.

6. The workstation according to any one of claim 2, wherein the planar storage mechanism comprises a candidate channel, the order container conveyor comprises a picking channel, the candidate channel is located on a lateral side of the picking channel, the delivery position is disposed on the picking channel, the candidate channel is configured to place a candidate order container, to deliver the candidate order container to the picking channel based on the conveying sequence; and the candidate order container comprises an order container directly conveyed from the delivery position to the candidate channel or an order container conveyed from the three-dimensional storage mechanism to the candidate channel.

7. The workstation according to claim 6, wherein the candidate channel and the picking channel are parallel to each other, the candidate channel is provided with a transfer device, and the transfer device is configured to transfer the candidate order container to the picking channel in a direction perpendicular to the picking channel, to enable the candidate order container to arrive at the delivery position based on the conveying sequence.

8. The workstation according to claim 6, wherein the planar storage mechanism further comprises a queuing channel, the queuing channel is located between the candidate channel and the picking channel, and a to-be-picked candidate order container in the candidate channel is configured to first pass through the queuing channel and then enter the picking channel.

9. The workstation according to claim 8, wherein the candidate channel, the queuing channel, and the picking channel are parallel to each other, the candidate channel is provided with a transfer device, and the transfer device is configured to transfer the candidate order container to the queuing channel in a direction perpendicular to the queuing channel, to queue the candidate order container in the queuing channel based on the conveying sequence, and sequentially convey the candidate order container from the queuing channel to the picking channel.

10. The workstation according to claim 6, further comprising a return line, wherein the return line is located at an end portion of the candidate channel and an end portion of the picking channel, and the return line communicates the candidate channel with the picking channel; and at least a part of order containers for which picking is incomplete on the picking channel return to the candidate channel through the return line.

11. The workstation according to claim 6, further comprising a vacant container line and a full container line, wherein the vacant container line is connected to an input end of the picking channel and configured to convey a vacant order container to the picking channel; and the full container line is configured to dock with an output end of the picking channel and configured to receive an order container for which picking is completed in the picking channel.

12. The workstation according to any one of claim 1, wherein both the order container conveyor and the source container conveyor are U-shaped, and are at least partially disposed surrounding the buffer mechanism.

13. The workstation according to claim 12, wherein when the order container is conveyed along different directions on the order container conveyor, different side surfaces of the order container face the conveying direction of the order container conveyor; or when the source container is conveyed along different directions along on source container conveyor, different side surfaces of the source container face a conveying direction of the source container conveyor.

14. The workstation according to any one of claim 1, wherein a sorting position is provided on a side of the sorting mechanism facing away from the buffer mechanism.

15. The workstation according to claim 14, wherein the source container conveyor is located above the order container conveyor; and the source container conveyor and the order container conveyor are disposed in a staggered manner in a horizontal direction, and a distance between the sorting position and a side of the source container conveyor close to the sorting position is greater than a distance between the sorting position and a side of the order container conveyor close to the sorting position.

16. A warehousing system, comprising a storage rack, a carrying mechanism, and the workstation according to claim 1, wherein the carrying mechanism is configured to carry a to-be-sorted source container from the storage rack to the workstation, or carry a sorted source container from the workstation to the storage rack.

17. The warehousing system according to claim 16, wherein there are a plurality of workstations, and source container conveyors of sorting mechanisms in adjacent ones of the workstations are in communication with each other; or order container conveyors of the sorting mechanisms in the adjacent ones of the workstations are in communication with each other.

18. A method for controlling workstation, performed by a controller of a workstation, wherein the workstation is the workstation according to claim 1, the method comprises:
obtaining an order task;
controlling the source container conveyor to convey a source container corresponding to the order task to the picking position of the source container conveyor;
controlling the order container conveyor to convey an order container corresponding to the source container to the delivery position of the order container conveyor;
after it is determined that items in the source container at the picking position have been delivered to the order container at the delivery position, determining whether a picking task is completed for the order container, and if not, controlling the order container conveyor to convey the order container to the buffer mechanism for temporary storage; and
controlling the buffer mechanism to convey the temporarily stored order container to the delivery position based on the conveying sequence.

19. The method for controlling workstation according to claim 18, wherein the controlling the order container conveyor to convey the order container corresponding to the source container to the delivery position of the order container conveyor further comprises:
determining whether an order corresponding to the source container is an order that is in processing but not completely processed; and
if yes, controlling the buffer mechanism to provide, for the order container conveyor, an order container corresponding to the order and temporarily stored in the buffer mechanism; or
if not, controlling the order container conveyor to obtain a vacant order container and convey the vacant order container to the delivery position for processing the order.

20. The method for controlling workstation according to claim 19, wherein when the buffer mechanism comprises a planar storage mechanism and a three-dimensional storage mechanism, duration before an order container that passes through the delivery position but for which picking is incomplete is hit again is determined; and
if the duration before the order container is hit again is less than or equal to a preset threshold, the corresponding order container is buffered into a candidate channel or a queuing channel; or
if the duration before the order container is hit again is greater than the preset threshold, the corresponding order container is buffered into the three-dimensional storage mechanism.
